(19) United States
(12) Patent Application Publication
(10) Pub. No.: US 2022/0287076 A1
(43) Pub. Date: Sep. 8, 2022

(54) GAP BETWEEN TWO DOWNLINK CONTROL INFORMATION WITH PDCCH REPETITION

(71) Applicant: QUALCOMM Incorporated, San Diego, CA (US)

(72) Inventors: Mostafa KHOSHNEVISAN, San Diego, CA (US); Xiaoxia ZHANG, San Diego, CA (US); Peter GAAL, San Diego, CA (US)

(21) Appl. No.: 17/653,285

(22) Filed: Mar. 2, 2022

Related U.S. Application Data
(60) Provisional application No. 63/157,132, filed on Mar. 5, 2021.

(51) Int. Cl. H04W 72/14; H04W 72/12

(52) U.S. Cl. CPC H04W 72/14; H04W 72/1289

(57) ABSTRACT

Aspects presented herein may enable a UE to indicate a support for a minimum time separation between monitoring occasions of two DCI in which at least one of the two DCI is received from a base station using linked PDCCH repetition. In one aspect, a UE transmits information indicating support for a minimum time separation between monitoring occasions for a pair of linked PDCCH candidates comprising one or more repetitions of a first DCI and a second DCI. The UE monitors for at least one of the first DCI or the second DCI based on the indicated minimum time separation.

### CROSS REFERENCE TO RELATED APPLICATION(S)

This application claims the benefit of and priority to U.S. Provisional Application Ser. No. 63/157,132, entitled “GAP BETWEEN TWO DOWNLINK CONTROL INFORMATION WITH PDCCH REPETITION” and filed on Mar. 5, 2021, which is expressly incorporated by reference herein in its entirety.

### TECHNICAL FIELD

The present disclosure relates generally to communication systems, and more particularly, to wireless communication involving physical downlink control channel (PDCCH).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus transmits information indicating support for a minimum time separation between monitoring occasions for a pair of linked physical downlink control channel (PDCCH) candidates comprising one or more repetitions of a first downlink control information (DCI) and a second DCI. The apparatus monitors for at least one of the first DCI or the second DCI based on the indicated minimum time separation.

In an aspect of the disclosure, a method, a computer-readable medium, and an apparatus are provided for wireless communication at a base station. The apparatus receives information indicating support for a minimum time separation between monitoring occasions for a pair of linked PDCCH candidates comprising one or more repetitions of a first DCI and a second DCI. The apparatus transmits the first DCI and the second DCI based on the indicated minimum time separation.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network in accordance with aspects presented herein.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network in accordance with various aspects of the present disclosure.

FIG. 4 is a diagram illustrating an example of time and frequency for multiple bandwidth parts (BWPs), and a control resource set (CORESET) for each BWP in accordance with various aspects of the present disclosure.

FIGS. 5A and 5B are diagrams illustrating examples of physical downlink control channel (PDCCH) monitoring occasions in accordance with various aspects of the present disclosure.

FIGS. 6A and 6B are diagrams illustrating examples of PDCCH monitoring occasions with downlink control information (DCI) gap and without DCI gap in accordance with various aspects of the present disclosure.

FIGS. 7A and 7B are diagrams illustrating examples of PDCCH candidates linking in accordance with various aspects of the present disclosure.

FIG. 8 is a communication flow illustrating an example of determining/defining a minimum time separation between two consecutive DCI according to aspects of the present disclosure.

FIGS. 9A and 9B are diagrams illustrating examples of determining a minimum time separation according to aspects of the present disclosure.

FIGS. 10A and 10B are diagrams illustrating examples of determining a minimum time separation according to aspects of the present disclosure.

FIGS. 11A and 11B are diagrams illustrating examples of determining a minimum time separation according to aspects of the present disclosure.

FIGS. 12A and 12B are diagrams illustrating examples of determining a minimum time separation according to aspects of the present disclosure.

FIG. 13 is a diagram illustrating an example of determining a minimum time separation according to aspects of the present disclosure.

FIG. 14 is a diagram illustrating an example of determining a minimum time separation according to aspects of the present disclosure.

FIG. 15 is a flowchart of a method of wireless communication in accordance with aspects presented herein.

FIG. 16 is a diagram illustrating an example of a hardware implementation for an example apparatus in accordance with aspects presented herein.

FIG. 17 is a flowchart of a method of wireless communication in accordance with aspects presented herein.

FIG. 18 is a diagram illustrating an example of a hardware implementation for an example apparatus in accordance with aspects presented herein.

### DETAILED DESCRIPTION

A UE may support PDCCH monitoring with a DCI time gap between PDCCH search space monitoring occasions. The DCI gap may correspond to a minimum time separation between PDCCH candidates. The DCI may apply for a cross-slot boundary, e.g., applying both between PDCCH candidates in the same slot and PDCCH candidates in different slots. The DCI gap may be applicable between monitoring occasions for a type 1 common search space (CSS) with dedicated radio control resource (RRC) configuration, a type 3 CSS, or a UE-specific search space (USS) with the DCI scrambled with a cell radio network temporary identifier (C-RNTI), a modulation coding scheme C-RNTI (MCS-C-RNTI), or a configured scheduling radio network temporary identifier (CS-RNTI). For example, the DCI gap may apply between two unicast DCI scheduling downlink, two unicast DCI scheduling uplink, and/or a unicast DCI scheduling downlink and a unicast DCI scheduling uplink. In some aspects, PDCCH candidates may include a repetition of DCI. Two PDCCH candidates may be linked together for repetition of the same DCI. Aspects presented herein enable the UE to indicate support for a DCI time gap between DCI including linked PDCCH candidates for repetition of DCI.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

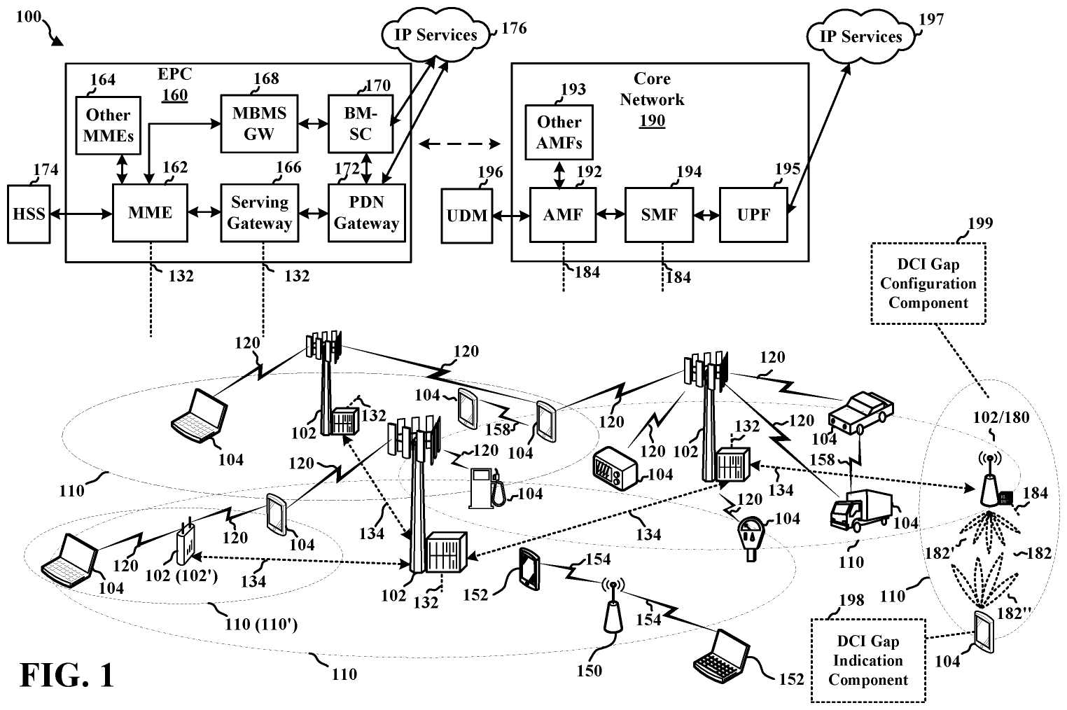

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

In certain aspects, the UE 104 may include a DCI gap indication component 198 configured to indicate a support for a minimum time separation between monitoring occasions of two DCI in which at least one of the two DCI is received from a base station using linked PDCCH repetition. In one configuration, the DCI gap indication component 198 may be configured to transmit information indicating support for a minimum time separation between monitoring occasions for a pair of linked PDCCH candidates comprising one or more repetitions of a first DCI and a second DCI. In such configuration, the DCI gap indication component 198 may monitor for at least one of the first DCI or the second DCI based on the indicated minimum time separation.

In certain aspects, the base station 102/180 may include a DCI gap configuration component 199 configured to transmit two DCI with a minimum time separation based on a UE capability indication in which at least one of the two DCI is transmitted using linked PDCCH repetition. In one configuration, the DCI gap configuration component 199 may be configured to receive information indicating support for a minimum time separation between monitoring occasions for a pair of linked PDCCH candidates comprising one or more repetitions of a first DCI and a second DCI. In such configuration, the DCI gap configuration component 199 may transmit the first DCI and the second DCI based on the indicated minimum time separation.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

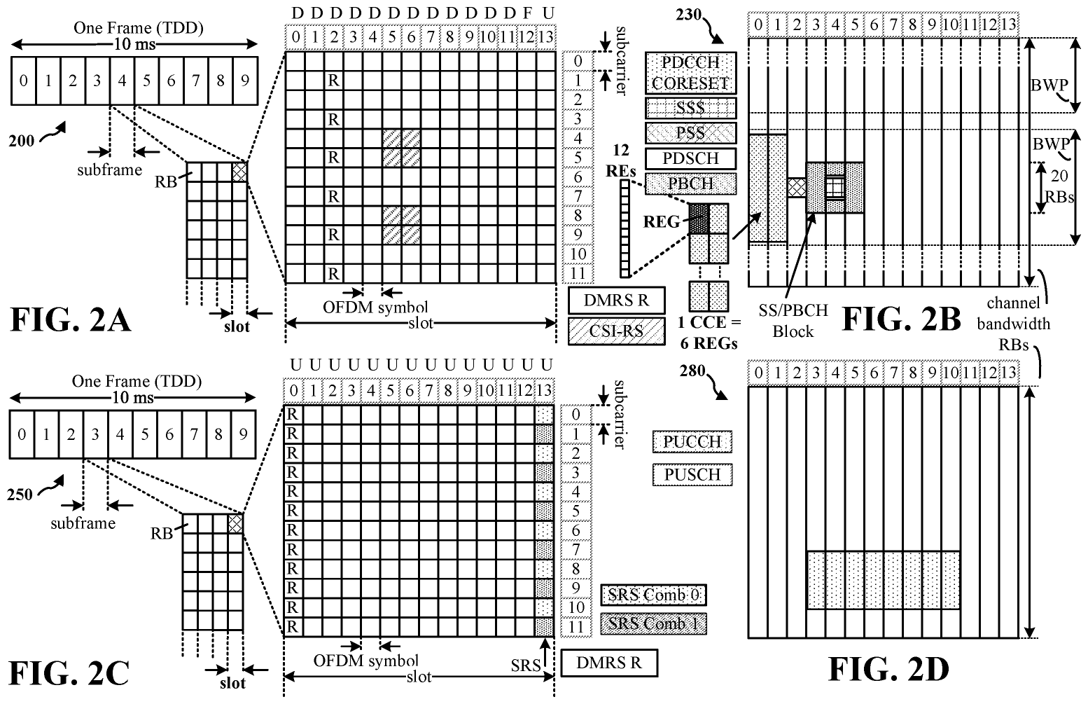

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

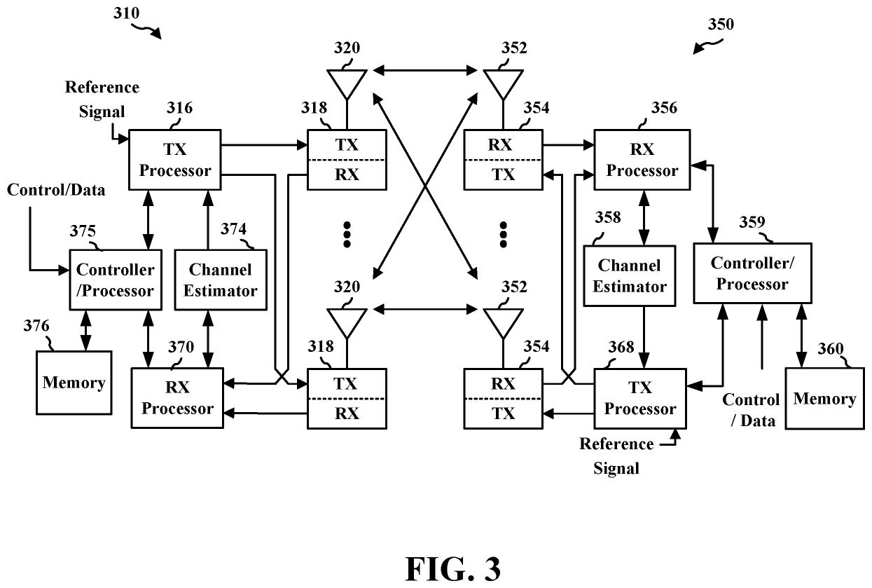

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the DCI gap indication component 198 of FIG. 1.

At least one of the TX processor 316, the RX processor 370, and the controller/processor 375 may be configured to perform aspects in connection with the DCI gap configuration component 199 of FIG. 1.

A communication network may support the use of bandwidth parts (BWPs), where a BWP may be a contiguous set of PRBs on a component carrier (CC). In other words, the BWP may be contiguous in frequency. Data and control channels may be received and/or transmitted within the BWP. The BWPs may provide the network with more flexibility in assigning resources in a CC as the BWPs may enable multiplexing of different signals and/or signal types for a more efficient use of the frequency spectrum and of UE power. A CC may be divided into multiple BWPs (e.g., one to four BWPs per CC) for uplink and/or downlink transmissions. For example, a UE may be configured with up to four downlink BWPs and up to four uplink BWPs for each serving cell. Although multiple BWPs may be defined in the downlink and the uplink, there may be one active BWP in the downlink and/or one active BWP in the uplink at a given time on an active serving cell. The active BWP may define the UE's operating bandwidth within the cell's operating bandwidth. The UE may not use BWPs that are configured for the UE but are not activated (e.g., deactivated or otherwise not in the active state) to transmit or receive data.

A BWP may further be configured with various parameters which may include numerology, frequency location, bandwidth size, and/or control resource set (CORESET). A CORESET may define frequency domain resource blocks (RBs) and time domain durations (i.e., number of consecutive symbols) of the control region of PDCCH. For example, a CORESET may correspond to a set of physical resources in time and frequency that a UE uses to monitor for PDCCH/DCI, where each CORESET may include one or more RBs in the frequency domain and one or more symbols in the time domain. As an example, a CORESET might include multiple RBs in the frequency domain and 1, 2, or 3 contiguous symbols in the time domain. A resource element (RE) is a unit indicating one subcarrier in frequency over a single symbol in time. A control channel element (CCE) may include resource element groups (REGs), e.g., 6 REGs, in which an REG may correspond to one RB (e.g., 12 REs) during one OFDM symbol. REGs within a CORESET may be numbered in an increasing order in a time-first manner, starting with zero (0) for the first OFDM symbol and the lowest-numbered RB in the CORESET. A UE may be configured with multiple CORESETs (e.g., up to three or five) in a BWP of a serving cell, each CORESET being associated with a CCE-to-REG mapping. Each CORESET may be assigned with a CORESET identifier (ID). As each UE may use up to four BWPs in a transmission, a UE may be configured with up to 12 CORESETs on a serving cell, where each CORESET may be assigned with an index of 0-11 (e.g., CORESET #0, CORESET #1, CORESET #2, etc.). CORESET with ID=0 (e.g., CORESET #0) may be configured by a master information block (MIB).

For receiving a PDCCH, a UE may perform blind decoding on the PDCCH as the UE may be configured with multiple PDCCH candidates to monitor. As multiple PDCCHs may be transmitted by a base station in a given time (e.g., in a single subframe) and one or more PDCCHs within the transmission may not be dedicated to the UE (e.g., they may be dedicated to other UEs), the UE may find the PDCCH dedicated to the UE within the transmission by monitoring a set of PDCCH candidates (e.g., a set of consecutive CCEs on which a PDCCH could be mapped) in a configured duration (e.g., every subframe). The UE may try to blind decode each PDCCH candidate using its radio network temporary identifier (RNTI). If a PDCCH candidate's cyclic redundancy check (CRC) is demasked by the UE's RNTI without a CRC error, the UE may determine that the PDCCH candidate carries the UE's control information (e.g., is dedicated to the UE).

When a UE performs blind decoding for a set of PDCCH candidates, the set of PDCCH candidates to be monitored by the UE may be configured for the UE by search space (SS) sets. Thus, an SS set associated with a CORESET may be used to define the slot pattern and starting symbol of the control region in each slot of the pattern. A UE may determine the slot for monitoring the SS set based on the periodicity, the offset and/or the duration associated with the SS set. There may be one or more types of SS sets, such as a common SS (CSS) set that is generally monitored by a group of UEs in a cell, and there may be a UE-specific SS set that is monitored by a specific UE, etc. For example, a Type0-PDCCH CSS set may be used for PDCCH scheduling system information block 1 (SIB1), a Type0A-PDCCH CSS set may be used for PDCCH scheduling other system information (OSI), a Type1-PDCCH CSS set may be used for PDCCH relating to random access, a Type2-PDCCH CSS set may be used for PDCCH scheduling page message, a Type3-PDCCH CSS set may be used for all the other PDCCHs monitored in CSS, a UE specific search space (USS) set may be used for PDCCH scheduling UE specific data, etc.

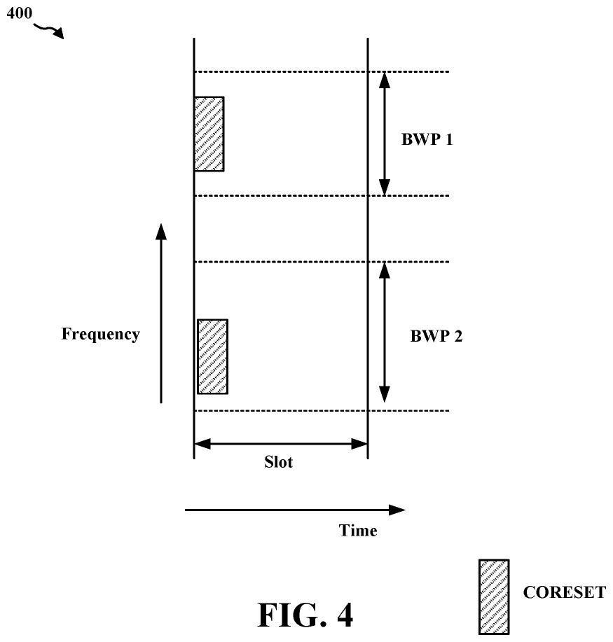

CORESETs may be defined at the cell level and the list of CORESETs to be monitored by a UE may be indicated in an active BWP. A base station may configure multiple CORESETs and multiple SS sets for a UE in an active BWP. For example, the base station may configure up to three CORESETs and ten SS sets per BWP for the UE. As a UE may be configured with multiple BWPs (e.g., up to four BWPs), the UE may be configured with up to 40 SS sets and 12 CORESETs, where each SS set may be assigned with an index of 0-39 and each CORESET may be assigned with an index of 0-11). Each SS set may be associated with a CORESET. Each CORESET ID of the CORESETs configured for the UE may map to a particular BWP, and each SS set ID of the multiple SS sets configured for the UE may map to a particular BWP, for example. FIG. 4 illustrates an example time and frequency diagram 400 showing multiple BWPs, and a CORESET for each BWP. An SS may comprise a set of CCEs, e.g., at different aggregation levels. For example, the SS may indicate a number of candidates to be decoded, e.g., in which the UE performs decoding.

Each CORESET may be associated with one active (transmission configuration indicator) TCI state. As part of CORESET configurations, RBs of a CORESET in frequency domain and/or number of symbols of the CORESET (e.g., one (1), two (2), or three (3) OFDM symbols) may be RRC configured by a base station. Each SS set may be associated with one CORESET, where there may be up to ten (10) SS sets in a BWP of the CC. As part of SS set configurations, at least one of the followings may be RRC configured for a UE by a base station: (1) the associated CORESET; (2) monitoring slots periodicity and offset (e.g., in terms of slots) and/or monitoring symbols with slot in which a UE may use for determining PDCCH monitoring occasions (MOs) of the SS set; (3) SS set type: Common SS (CSS) or UE-specific SS (USS); (4) DCI format(s) to monitor; and/or (5) number of PDCCH candidates for a configured aggregation level, etc. PDCCH candidates may be defined as part of SS set configurations, where a PDCCH candidate with a configured aggregation level and a configured candidate index may be defined in a configured SS set. A UE may receive DCI in one PDCCH candidate, where the UE may monitor one or more PDCCH candidates in one or more SS sets, and one or more PDCCH candidates with CRC pass (e.g., successful decoding) correspond to a decoded DCI (e.g., based on the UE's blind decoding).

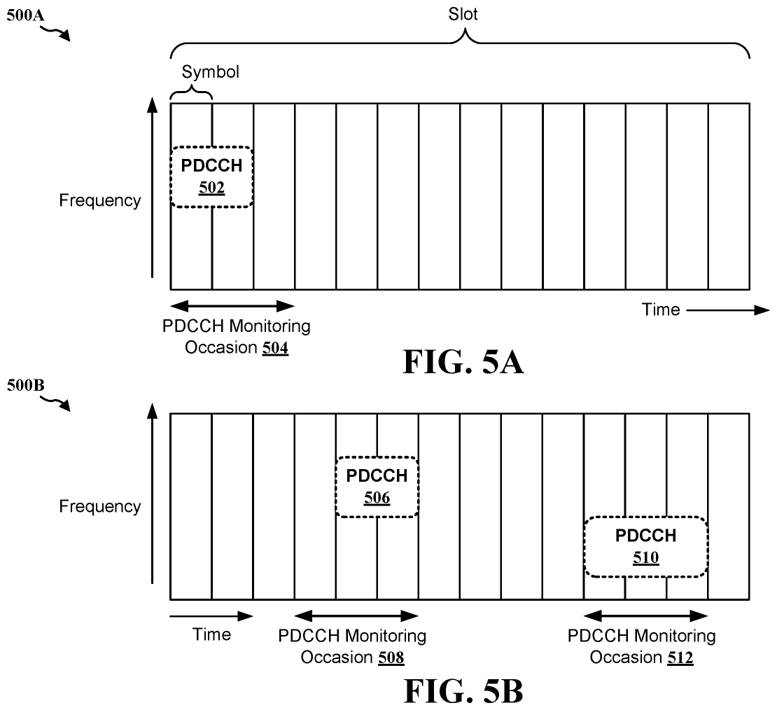

In some examples, a base station may configure the time and/or the duration for one or more PDCCH monitoring occasions for a UE (e.g., via an RRC configuration) based at least in part on the UE's capability, such as for CSS with dedicated RRC configuration (e.g., Type 1 CSS), Type 3 CSS, and USS, etc. In one example, as shown by a diagram 500A of FIG. 5A, a UE may be configured by a base station to monitor for a PDCCH 502 within the first three (3) OFDM symbols of a slot in a monitoring occasion 504, which may apply to UEs with basic UE capabilities (or lower/reduced UE capabilities), e.g., a UE may indicate its UE capability to the base station. In another example, as shown by a diagram 500B of FIG. 5B, a UE may be configured by a base station to monitor for a PDCCH within a span of three (3) consecutive OFDM symbols in a slot in a single monitoring occasion. For example, the UE may be configured to monitor for a PDCCH 506 within the fourth, fifth, and sixth symbols of a slot in a monitoring occasion 508, or the UE may be configured to monitor for a PDCCH 510 within the eleventh, twelfth, and thirteen symbols of a slot in a monitoring occasion 512, etc.

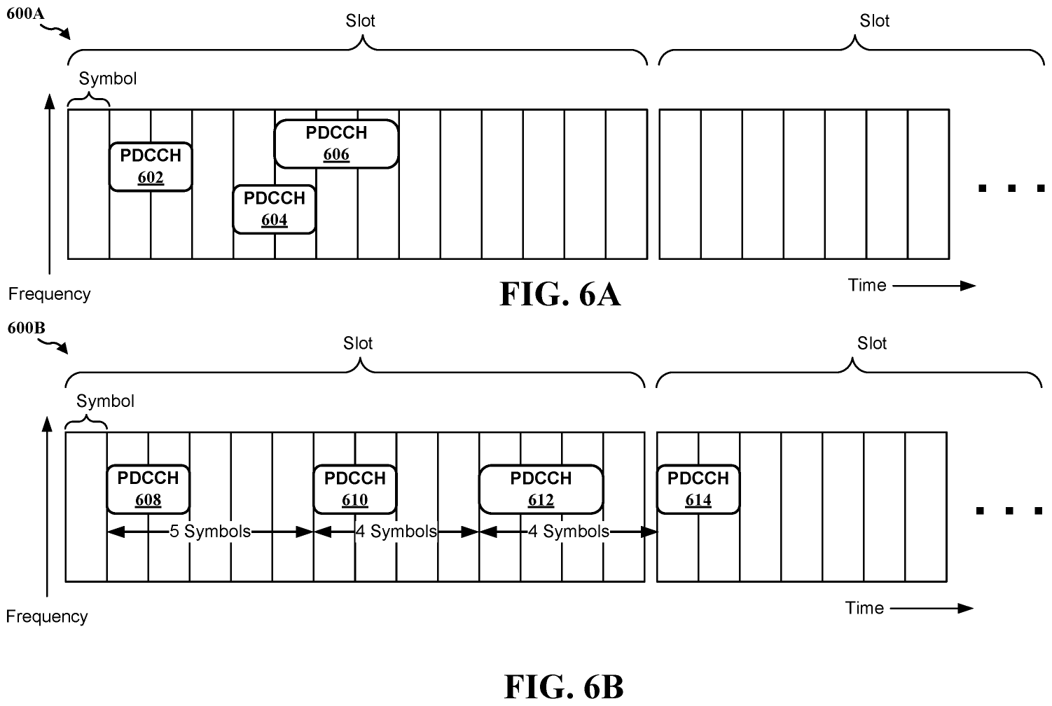

In some examples, a UE may be configured by a base station to monitor for one or more PDCCHs in multiple monitoring occasions within a slot and/or between slots, where each monitoring occasion may be any OFDM symbol(s) of a slot depending on the UE's capability and/or configuration. For example, a UE may indicate to a base station that the UE supports a capability to monitor for multiple PDCCHs without a time gap between DCI, such as by transmitting a “withoutDCI-Gap” indication in a “pdcch-MonitoringAnyOccasions” parameter to the base station. Based on the indication, as shown by a diagram 600A of FIG. 6A, the base station may configure CORESETs/search space sets that provide multiple PDCCH monitoring occasions within/across slots, and the base station may transmit/schedule multiple PDCCHs, such as PDCCHs 602, 604, and 606 to the UE anywhere in a slot (e.g., without a gap between two consecutive PDCCHs/DCI) within the multiple PDCCH monitoring occasions.

In another example, a UE may indicate to a base station that the UE supports a capability for monitoring PDCCH monitoring occasions with a time gap between monitored PDCCH candidates. The time gap, or time separation, between PDCCH candidates may be referred to as a DCI gap. In some aspects, the UE may indicate to the base station that the UE does not support monitoring for multiple PDCCHs without a gap and/or supports the capability to monitor for multiple PDCCHs with a time gap. The UE may provide the indication to the base station in RRC signaling (e.g. UE capability signaling). In some aspects, the UE may make the indication by transmitting a “withDCI-Gap” indication in the “pdcch-MonitoringAnyOccasions” parameter to the base station. The “withDCI-gap” indication may indicate whether the UE supports PDCCH search space monitoring occasions in any symbol of the slot with a minimum time separation of two (2) OFDM symbols for 15 kHz subcarrier spacing (SCS), four (4) OFDM symbols for 30 kHz SCS, seven (7) OFDM symbols for 60 kHz SCS with a normal cyclic prefix (NCP), and fourteen (14) OFDM symbols for 120 kHz SCS between two consecutive transmissions of PDCCH scrambled with C-RNTI, MCS-C-RNTI, or CS-RNTI, etc. For example, as shown by a diagram 600B of FIG. 6B, if a BWP is associated with 30 kHz SCS and a UE indicates to a base station that the UE does not have the capabilities to monitor for multiple PDCCHs without a gap (e.g., the UE transmits the “withDCI-Gap” indication to the base station), the base station may be configured to transmit multiple PDCCHs to the UE with a minimum time separation of four (4) symbols between PDCCH transmissions of DCI, or between PDCCH candidates for which the DCI is transmitted. For example, as shown in FIG. 6B, the base station may transmit a first PDCCH 608, a second PDCCH 610, a third PDCCH 612, and a fourth PDCCH 614 to the UE, where there is a five (5) symbol gap between the starting symbol of the first PDCCH 608 and the starting symbol of the second PDCCH 610, a four (4) symbol gap between the starting symbol of the second PDCCH 610 and the starting symbol of the third PDCCH 612, and a four (4) symbol gap between the starting symbol of the third PDCCH 612 and the starting symbol of the fourth PDCCH 614. Thus, each of the adjacent PDCCH transmissions has a time gap of at least 4 symbols. As shown between the third PDCCH 612 and the fourth PDCCH 614, the minimum time separation may also apply to PDCCHs transmitted in different slots (e.g., for cross-slot boundary cases and configurations). DCI transmitted in a PDCCH may be an uplink (UL) DCI or a downlink (DL) DCI. As such, the minimum time separation may apply to a gap between two DL unicast DCI, between two UL unicast DCI, and/or between a DL and an UL unicast DCI, etc. For example, the time gap may be applicable between monitoring occasions for a type 1 CSS with dedicated RRC configuration, a type 3 CSS, or a USS with the DCI scrambled with a C-RNTI, an MCS-C-RNTI, or a CS-RNTI. In some aspects, the time gap may be applicable between DCI of particular DCI formats, such as DCI formats 1_0, 1_1, and 1_2 for DCI scheduling downlink transmissions and DCI formats 0_0, 0_1, and 0_2 for DCI scheduling uplink transmissions. Thus, in some aspects, the time gap may be applicable between DCI of any of DCI formats 1_0, 1_1, 1_2, 0_0, 0_1, and/or 0_2.

A base station may transmit PDCCH to a UE with repetitions, e.g., repetitions of DCI, to improve the communication reliability, where each PDCCH repetition may be transmitted in a PDCCH candidate. In some examples, multiple PDCCH candidates may be linked together for repetition of a same DCI. For example, if two PDCCH candidates have a same aggregation level (AL) (e.g., a same number of control channel elements (CCEs)) and a base station is configured to use the two PDCCH candidates for transmitting a same DCI payload to a UE, the base station may link the two PDCCH candidates together. Then, the base station may inform the linking (e.g., the relationship between the two PDCCH candidates) to the UE, such that the UE may know that the two PDCCH candidates are linked for DCI repetition before decoding the DCI. Then, the UE may perform a soft combining of the PDCCH received in the two PDCCH candidates to decode the DCI.

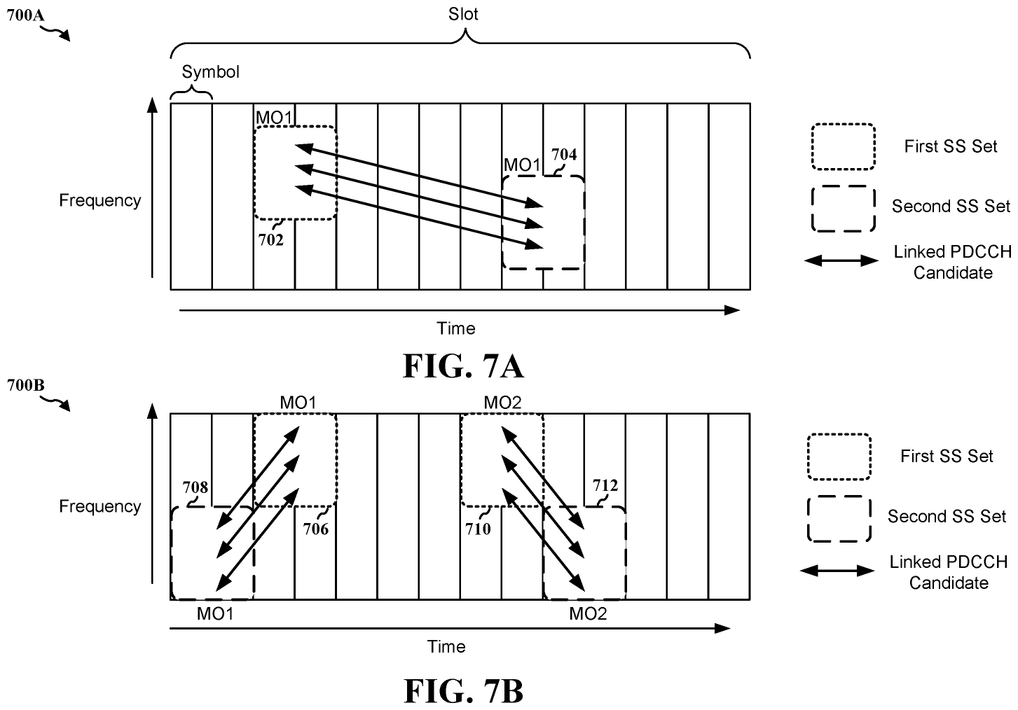

FIG. 7A is a diagram 700A illustrating an example of PDCCH candidates linking in a PDCCH monitoring occasion for DCI repetition in accordance with various aspects of the present disclosure. A base station may link a first set of PDCCH candidates that is associated with a first SS set 702 to a second set of PDCCH candidates that is associated with a second SS set 704, where the first SS set 702 and the second SS set 704 may be linked by an RRC configuration, e.g., the relationship between the linked PDCCH candidates being indicated to the UE in RRC signaling from the base station. The base station may apply a one-to-one mapping for the PDCCH candidates in the linked first SS set 702 and the second SS set 704, such that the monitoring occasions of the two linked SS sets are also one-to-one mapped. In addition, the base station may link PDCCH candidates with a same AL and a same candidate index in the two linked SS sets or in two linked monitoring occasions. For example, if the first SS set 702 is associated with three (3) PDCCH candidates that are configured with aggregation level two (e.g., AL=2) and the second SS set 704 is also associated with three (3) PDCCH candidates that are configured with aggregation level two (e.g., AL=2), the base station may apply a one-to-one mapping to link the three (3) PDCCH candidates associated with the first SS set 702 to the three (3) PDCCH candidates associated with the second SS set 704. In other words, two linked SS sets may be configured with a same number of PDCCH candidates for each AL. Then, the base station may indicate the linking to the UE, such that the UE may monitor for PDCCH candidates in the first SS set 702 and the second SS set 704 in a pair of linked monitoring occasions. In one example, based on the linking, the UE may decode DCI or a first portion of the DCI in the first SS set 702, and the UE may also decode the DCI (e.g., the DCI repetition) or a second portion of the DCI in the second SS set 704. Then, the UE may combine DCI monitored and received in the first SS set 702 and the second SS set 704 to decode the DCI. While the diagram 700A shows the first SS set 702 and the second SS set 704 are configured within a same slot (e.g., an intra-slot PDCCH repetition), it is merely for illustration purposes. The base station may also be configured to link an SS set in a slot with another SS set in a different slot (e.g., for an inter-slot PDCCH repetition).

FIG. 7B is a diagram 700B illustrating an example of a PDCCH candidates linking in multiple PDCCH monitoring occasions in accordance with various aspects of the present disclosure. A base station may link a first set of PDCCH candidates that is associated with a first SS set 706 to a second set of PDCCH candidates that is associated with a second SS set 708 for DCI repetition, and a UE may be configured to monitor for a first DCI and in the first SS set 706 and a repetition of the first DCI in the second SS set 708 in a first pair of linked monitoring occasions (e.g., MO1). Similarly, the base station may link a third set of PDCCH candidates that is associated with a third SS set 710 to a fourth set of PDCCH candidates that is associated with a fourth SS set 712 for DCI repetition, where the UE may also monitor for a second DCI in the third SS set 710 and a repetition of the second DCI in the fourth SS set 712 in a second pair of linked monitoring occasions (e.g., MO2). The base station may inform the UE about the linking through an RRC configuration. The base station may apply a one-to-one mapping for the PDCCH candidates in the linked first SS set 706 and the second SS set 708, and for the PDCCH candidates in the linked third SS set 710 and the fourth SS set 712, where the PDCCH candidates with the same AL and the same candidate index in the two linked SS sets may be one-to-one mapped. In response, the UE may monitor for the first DCI in the first SS set 706 and the repetition of the first DCI in the second SS set 708 in the first pair of monitoring occasions, and the UE may combine the first DCI received in the first SS set 706 and the repetition of the first DCI in the second SS set 708 to decode the first DCI. Similarly, the UE may monitor for the second DCI in the third SS set 710 and the repetition of the second DCI in the fourth SS set 712 in the second pair monitoring occasions. The UE may combine the second DCI received in the third SS set 710 and the fourth SS set 712 to decode the second DCI. While the diagram 700B shows the first SS set 706, the second SS set 708, the third SS set 710, and the fourth SS set 712 are configured to be within a same slot (e.g., an intra-slot PDCCH repetition), it is merely for illustration purposes. The base station may also be configured to link an SS set in a slot with another SS set in a different slot (e.g., for an inter-slot PDCCH repetition). For example, at least one of the first SS set 706, the second SS set 708, the third SS set 710, and/or the fourth SS set 712 may be configured to be at a different slot.

Aspects presented herein may enable a UE to indicate and/or a base station to apply a time separation (e.g., a minimum time separation/gap) between two DCI (e.g., two consecutive unicast DCI) for PDCCH monitoring when at least one of the two DCI is transmitted based on PDCCH repetition in linked PDCCH candidates, such as when the UE does not have the capability to monitor for multiple PDCCHs/DCI without a gap or supports a capability to monitor for PDCCH with a DCI gap (e.g., the UE transmits a “withDCI-Gap” indication for the “pdcch-MonitoringAnyOccasions” parameter to the base station), as described in connection with FIG. 6A.

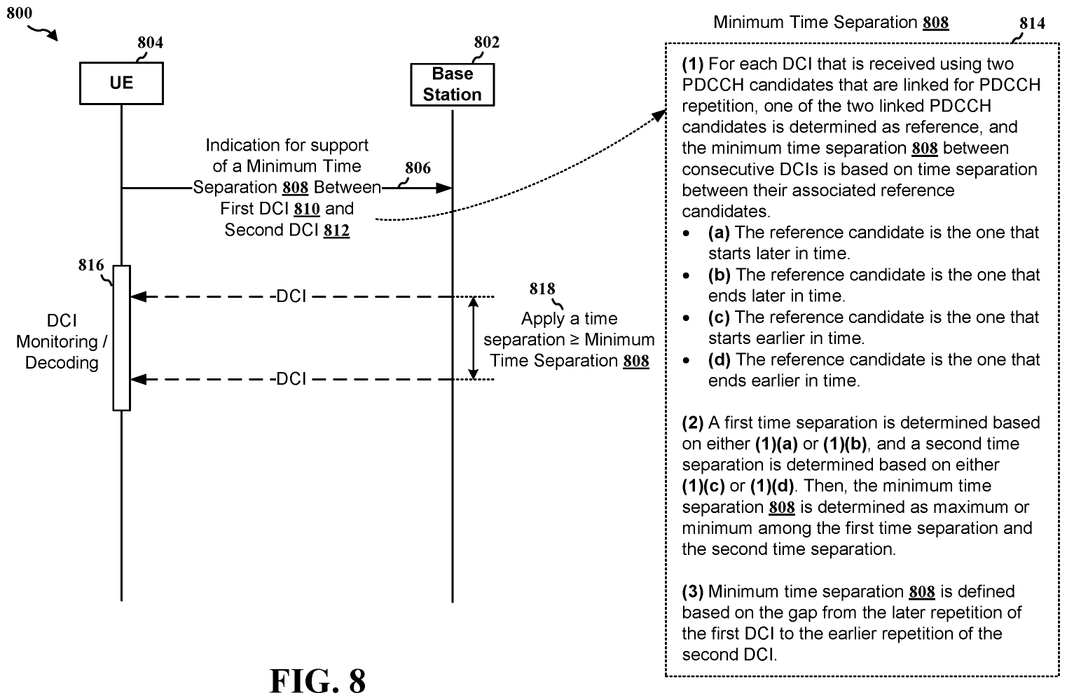

FIG. 8 is a communication flow 800 illustrating example aspects of determining/defining a minimum time separation between two consecutive DCI according to aspects of the present disclosure, where a UE may receive and/or a base station may transmit at least one of the DCI using two PDCCH candidates that are linked for PDCCH repetition.

In one aspect, as shown at 806, a UE 804 may transmit information, such as a UE capability indication, to a base station 802 which indicates the UE 804's support for a minimum time separation 808 between monitoring occasions for a first DCI 810 (e.g., a pair of monitoring occasions for the first DCI 810) and a second DCI 812, and at least one of the first DCI 810 or the second DCI 812 is to be transmitted using a pair of linked PDCCH candidates configured for transmitting PDCCH repetitions, such as described in connection with FIGS. 6B, 7A, and 7B. For example, the UE 804 may transmit an indication for PDCCH monitoring on any occasion with DCI gap (e.g., the “withDCI-Gap” indication in the “pdcch-MonitoringAnyOccasions” parameter) to the base station 802.

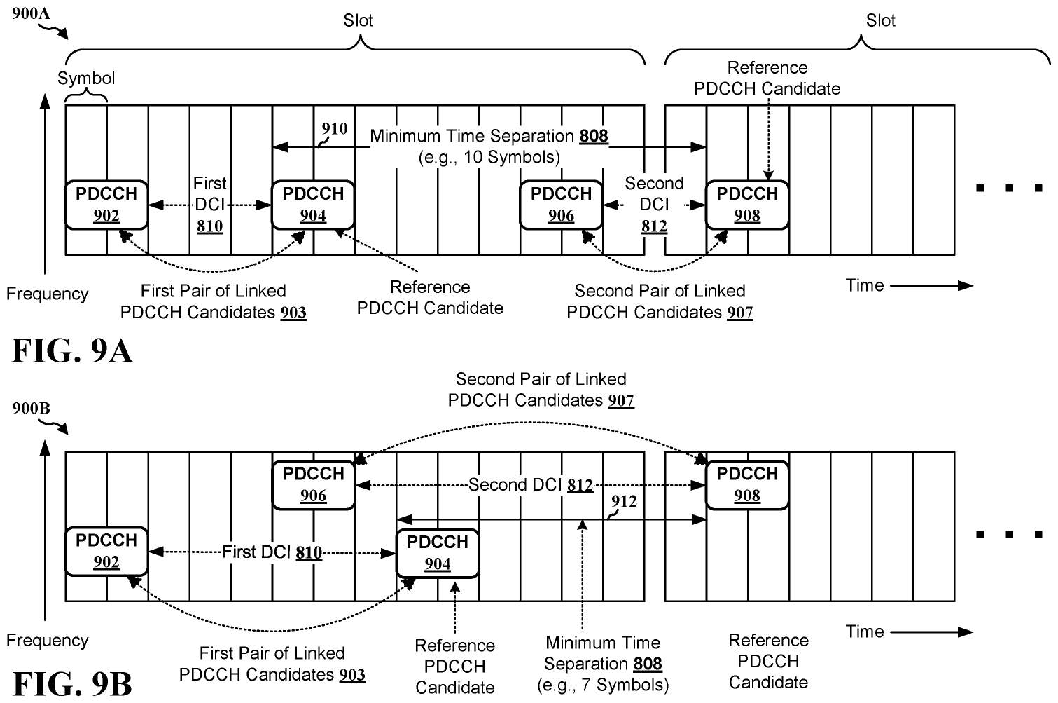

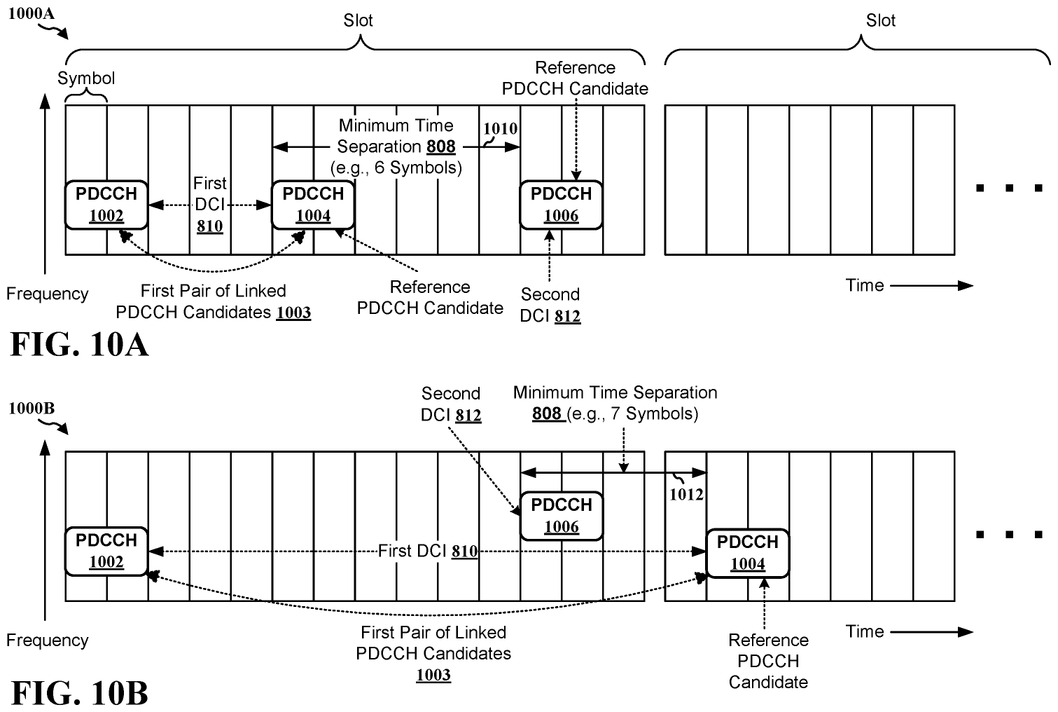

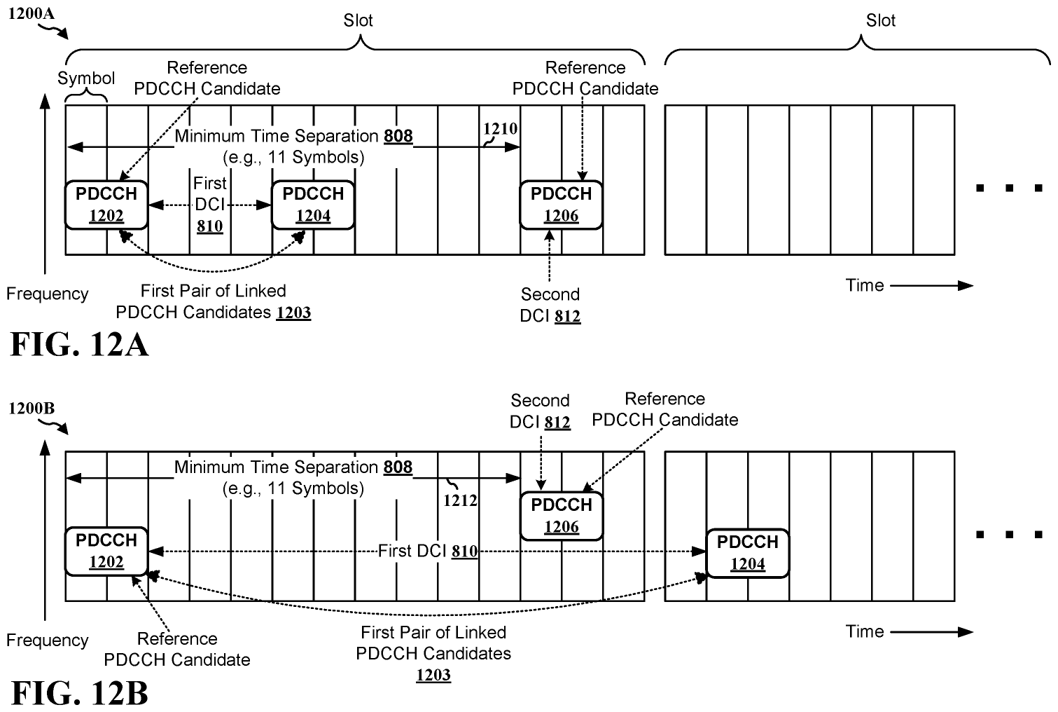

The minimum time separation 808 may be defined for the UE 804 and the base station 802 in a variety of ways. In one example, for each DCI (e.g., the first DCI 810 and/or the second DCI 812) that is received using two PDCCH candidates, including at least one PDCCH candidate that is linked for PDCCH repetition, one of the two linked PDCCH candidates may be determined as a reference PDCCH candidate, and the minimum time separation 808 between the consecutive DCI (e.g., the first DCI 810 and/or the second DCI 812) may be based on the time separation between the reference candidate (e.g., Option 1) and the other DCI. In some examples, the minimum time separation may be applied between a PDCCH candidate that is one of a set of linked PDCCH candidates and another PDCCH candidate that is one of a different set of linked PDCCH candidates, such as illustrated in FIGS. 9A, 9B, 11A, 11B, 13, and/or 14. In other aspects, the minimum time separation may be applied between a PDCCH candidate that is one of a set of linked PDCCH candidates and an individual PDCCH candidate that is not linked for DCI repetition, such as illustrated in FIGS. 10A, 10B, 12A and/or 12B.

In one aspect of the present disclosure, as illustrated by (1)(a) at 814 of FIG. 8, the reference PDCCH candidate may be the PDCCH candidate that starts later in time in a linked pair of PDCCH candidates. For example, as shown by a diagram 900A of FIG. 9A, a first pair of linked PDCCH candidates 903 may include a first PDCCH candidate 902 that is linked to a second PDCCH candidate 904, which may be used for transmitting the first DCI 810 or a repetition of the first DCI 810. Similarly, a second pair of linked PDCCH candidates 907 may include a third PDCCH candidate 906 that is linked to a fourth PDCCH candidate 908, which may be used for transmitting the second DCI 812 or a repetition of the second DCI 812. If the reference PDCCH candidate is configured to be the PDCCH candidate that starts later in time in a linked pair of PDCCH candidates, then the second PDCCH candidate 904 may be the reference PDCCH candidate in the first pair of linked PDCCH candidates 903 as the second PDCCH candidate 904 starts later than the first PDCCH candidate 902. Similarly, the fourth PDCCH candidate 908 may be the reference PDCCH candidate in the second pair of linked PDCCH candidates 907 as the fourth PDCCH candidate 908 starts later than the third PDCCH candidate 906. Thus, the time separation between PDCCH candidates for the purpose of the minimum time separation may be based on the starting symbol of the second PDCCH candidate 904 and the starting symbol of the fourth PDCCH candidate 908. For example, as shown at 910, if the minimum time separation 808 is configured to be (or supported by the UE as) ten (10) symbols, the base station 802 may transmit the first pair of linked PDCCH candidates 903 and the second pair of linked PDCCH candidates 907 with the second PDCCH candidate 904 and the fourth PDCCH candidate 908 configured to be at least ten (10) symbols apart (e.g., between their starting symbols). In another example, the first pair of linked PDCCH candidates 903 and the second pair of linked PDCCH candidates 907 may be at least partially overlapped. For example, as shown by a diagram 900B of FIG. 9B, the third PDCCH candidate 906 of the second pair of linked PDCCH candidates 907 may be transmitted between the first PDCCH candidate 902 and the second PDCCH candidate 904 of the first pair of linked PDCCH candidates 903. In this example, as shown at 912, if the minimum time separation 808 is configured to be (or supported by the UE as) seven (7) symbols, the base station 802 may transmit the first pair of linked PDCCH candidates 903 and the second pair of linked PDCCH candidates 907 with the second PDCCH candidate 904 and the fourth PDCCH candidate 908 configured to be at least seven (7) symbols apart (e.g., between their starting symbols).

In some examples, one of the consecutive DCI may be transmitted with PDCCH repetition and the other DCI may not be transmitted with PDCCH repetition (e.g., the DCI is received using an individual/unlinked PDCCH candidate). In such examples, the DCI that is not transmitted with PDCCH repetition may not include a reference PDCCH candidate (or in other words, the reference PDCCH candidate may be the individual/unlinked PDCCH candidate), and the time separation may be determine between the individual/unlined PDCCH candidate and the reference PDCCH candidate for the set of linked PDCCH candidates. For example, as shown by a diagram 1000A of FIG. 10A, a first pair of linked PDCCH candidates 1003 may include a first PDCCH candidate 1002 that is linked to a second PDCCH candidate 1004, which may be used for transmitting the first DCI 810 or a repetition of the first DCI 810. The second DCI 812 may be transmitted in a third PDCCH candidate 1006. If the reference PDCCH candidate is configured to be the PDCCH candidate that starts later in time in a linked pair of PDCCH candidates, then the second PDCCH candidate 1004 may be the reference PDCCH candidate in the first pair of linked PDCCH candidates 1003 as the second PDCCH candidate 1004 starts later than the first PDCCH candidate 1002. As the third PDCCH candidate 1006 is not linked to another PDCCH candidate, in some aspects, the third PDCCH candidate 1006 may itself be considered a reference PDCCH candidate for the individual DCI that is not repeated. Thus, the time separation between PDCCH candidates for the purpose of the minimum time separation may be based on the starting symbol of the second PDCCH candidate 1004 and the starting symbol of the third PDCCH candidate 1006. For example, as shown at 1010, if the minimum time separation 808 is configured to be (or supported by the UE as) six (6) symbols, the base station 802 may transmit the first pair of linked PDCCH candidates 1003 and the third PDCCH candidate 1006 with the second PDCCH candidate 1004 and the third PDCCH candidate 1006 configured to be at least six (6) symbols apart (e.g., between their starting symbols). In another example, as shown by a diagram 1000B of FIG. 10B, the third PDCCH candidate 1006 may also be transmitted between the first PDCCH candidate 1002 and the second PDCCH candidate 1004 of the first pair of linked PDCCH candidates 1003. In this example, as shown at 1012, if the minimum time separation 808 is configured to be (or supported by the UE as) four (4) symbols, the base station 802 may transmit the first pair of linked PDCCH candidates 1003 and the third PDCCH candidate 1006 with the second PDCCH candidate 1004 and the third PDCCH candidate 1006 configured to be at least six (6) symbols apart (e.g., between their starting symbols).

In another aspect of the present disclosure, as illustrated by (1)(b) at 814 of FIG. 8, the reference PDCCH candidate may be the PDCCH candidate that ends later in time in a linked pair of PDCCH candidates. For example, referring back to the diagram 900A of FIG. 9A, if the reference PDCCH candidate is configured to be the PDCCH candidate that ends later in time in a linked pair of PDCCH candidates, then the second PDCCH candidate 904 may be the reference PDCCH candidate in the first pair of linked PDCCH candidates 903 as the second PDCCH candidate 904 ends later than the first PDCCH candidate 902. Similarly, the fourth PDCCH candidate 908 may be the reference PDCCH candidate in the second pair of linked PDCCH candidates 907 as the fourth PDCCH candidate 908 ends later than the third PDCCH candidate 906. Thus, the time separation between PDCCH candidates for the purpose of the minimum time separation may be based on the starting symbol of the second PDCCH candidate 904 and the starting symbol of the fourth PDCCH candidate 908. For example, as shown at 910, if the minimum time separation 808 is configured to be (or supported by the UE as) ten (10) symbols, the base station 802 may transmit the first pair of linked PDCCH candidates 903 and the second pair of linked PDCCH candidates 907 with the second PDCCH candidate 904 and the fourth PDCCH candidate 908 configured to be at least ten (10) symbols apart (e.g., between their starting symbols). In another example, as shown at 912 of the diagram 900B of FIG. 9B, if the minimum time separation 808 is configured to be (or supported by the UE as) seven (7) symbols, the base station 802 may transmit the first pair of linked PDCCH candidates 903 and the second pair of linked PDCCH candidates 907 with the second PDCCH candidate 904 and the fourth PDCCH candidate 908 configured to be at least seven (7) symbols apart (e.g., between their starting symbols).

Similarly, in some examples, one of the consecutive DCI may be transmitted with PDCCH repetition and the other DCI may not be transmitted with PDCCH repetition (e.g., the DCI is received using an individual/unlinked PDCCH candidate). In such examples, the DCI that is not transmitted with PDCCH repetition may not include a reference PDCCH candidate (or in other words, the reference PDCCH candidate may be the individual/unlinked PDCCH candidate). For example, as shown by a diagram 1000A of FIG. 10A, if the reference PDCCH candidate is configured to be the PDCCH candidate that ends later in time in a linked pair of PDCCH candidates, then the second PDCCH candidate 1004 may be the reference PDCCH candidate in the first pair of linked PDCCH candidates 1003 as the second PDCCH candidate 1004 ends later than the first PDCCH candidate 1002. As the third PDCCH candidate 1006 is not linked to another PDCCH candidate, the third PDCCH candidate 1006 may itself be the reference PDCCH candidate. Thus, the time separation between PDCCH candidates for the purpose of the minimum time separation may be based on the starting symbol of the second PDCCH candidate 1004 and the starting symbol of the third PDCCH candidate 1006. For example, as shown at 1010, if the minimum time separation 808 is configured to be (or supported by the UE as) six (6) symbols, the base station 802 may transmit the first pair of linked PDCCH candidates 1003 and the third PDCCH candidate 1006 with the second PDCCH candidate 1004 and the third PDCCH candidate 1006 configured to be at least six (6) symbols apart (e.g., between their starting symbols). In another example, as shown by a diagram 1000B of FIG. 10B, the third PDCCH candidate 1006 may also be transmitted between the first PDCCH candidate 1002 and the second PDCCH candidate 1004 of the first pair of linked PDCCH candidates 1003. In this example, as shown at 1012, if the minimum time separation 808 is configured to be (or supported by the UE as) four (4) symbols, the base station 802 may transmit the first pair of linked PDCCH candidates 1003 and the third PDCCH candidate 1006 with the second PDCCH candidate 1004 and the third PDCCH candidate 1006 configured to be at least six (6) symbols apart (e.g., between their starting symbols). In this example, the order of consecutive DCI may be the second DCI 812 (e.g., the PDCCH candidate 1006) and then the first DCI 810.

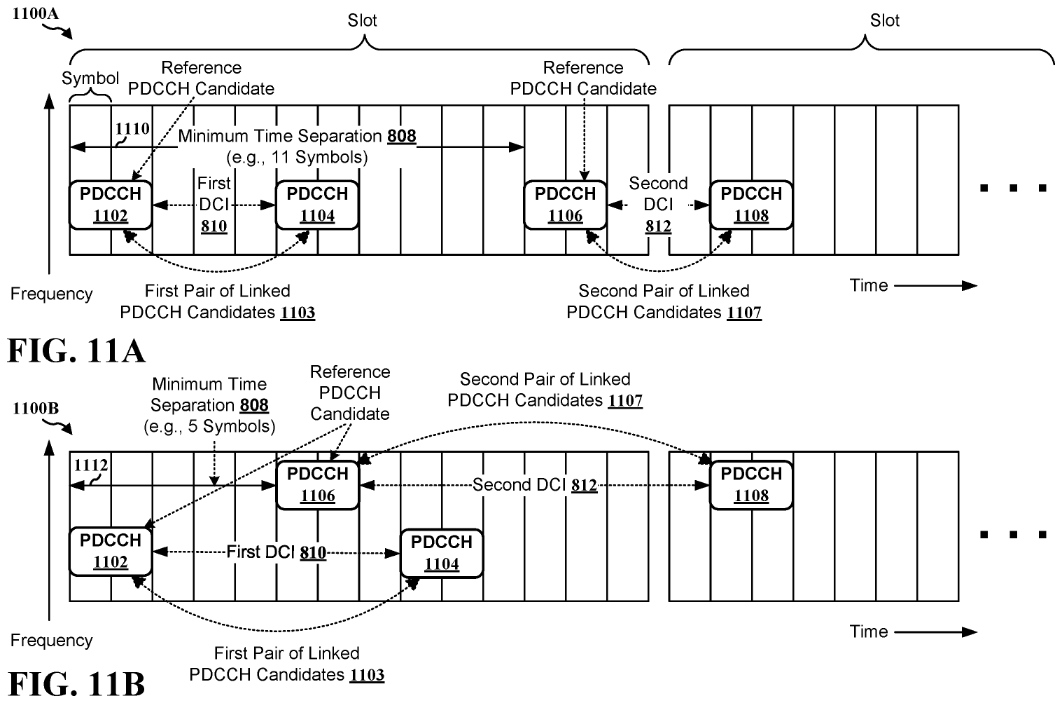

In another aspect of the present disclosure, as illustrated by (1)(c) at 814 of FIG. 8, the reference PDCCH candidate may be the PDCCH candidate that starts earlier in time in a linked pair of PDCCH candidates. For example, as shown by a diagram 1100A of FIG. 11A, a first pair of linked PDCCH candidates 1103 may include a first PDCCH candidate 1102 that is linked to a second PDCCH candidate 1104, which may be used for transmitting the first DCI 810 or a repetition of the first DCI 810. Similarly, a second pair of linked PDCCH candidates 1107 may include a third PDCCH candidate 1106 that is linked to a fourth PDCCH candidate 1108, which may be used for transmitting the second DCI 812 or a repetition of the second DCI 812. If the reference PDCCH candidate is configured to be the PDCCH candidate that starts earlier in time in a linked pair of PDCCH candidates, then the first PDCCH candidate 1102 may be the reference PDCCH candidate in the first pair of linked PDCCH candidates 1103 as the first PDCCH candidate 1102 starts earlier than the second PDCCH candidate 1104. Similarly, the third PDCCH candidate 1106 may be the reference PDCCH candidate in the second pair of linked PDCCH candidates 1107 as the third PDCCH candidate 1106 starts earlier than the fourth PDCCH candidate 1108. Thus, the time separation between PDCCH candidates for the purpose of the minimum time separation may be based on the starting symbol of the first PDCCH candidate 1102 and the starting symbol of the third PDCCH candidate 1106. For example, as shown at 1110, if the minimum time separation 808 is configured to be (or supported by the UE as) eleven (11) symbols, the base station 802 may transmit the first pair of linked PDCCH candidates 1103 and the second pair of linked PDCCH candidates 1107 with the first PDCCH candidate 1102 and the third PDCCH candidate 1106 configured to be at least eleven (11) symbols apart (e.g., between their starting symbols). In another example, the first pair of linked PDCCH candidates 1103 and the second pair of linked PDCCH candidates 1107 may be at least partially overlapped. For example, as shown by a diagram 1100B of FIG. 11B, the third PDCCH candidate 1106 of the second pair of linked PDCCH candidates 1107 may be transmitted between the first PDCCH candidate 1102 and the second PDCCH candidate 1104 of the first pair of linked PDCCH candidates 1103. In this example, as shown at 1112, if the minimum time separation 808 is configured to be (or supported by the UE as) five (5) symbols, the base station 802 may transmit the first pair of linked PDCCH candidates 1103 and the second pair of linked PDCCH candidates 1107 with the first PDCCH candidate 1102 and the third PDCCH candidate 1106 configured to be at least five (5) symbols apart (e.g., between their starting symbols).

In some examples, one of the consecutive DCI may be transmitted with PDCCH repetition and the other DCI may not be transmitted with PDCCH repetition (e.g., the DCI is received using an individual/unlinked PDCCH candidate). In such examples, the DCI that is not transmitted with PDCCH repetition may not include a reference PDCCH candidate (or in other words, the reference PDCCH candidate may be the individual/unlinked PDCCH candidate). For example, as shown by a diagram 1200A of FIG. 12A, a first pair of linked PDCCH candidates 1203 may include a first PDCCH candidate 1202 that is linked to a second PDCCH candidate 1204 for transmission of the first DCI 810 or a repetition of the first DCI 810. The second DCI 812 may be transmitted in a third PDCCH candidate 1206. If the reference PDCCH candidate is configured to be the PDCCH candidate that starts earlier in time in a linked pair of PDCCH candidates, then the first PDCCH candidate 1202 may be the reference PDCCH candidate in the first pair of linked PDCCH candidates 1203 as the first PDCCH candidate 1202 starts earlier than the second PDCCH candidate 1204. As the third PDCCH candidate 1206 is not linked to another PDCCH candidate, the third PDCCH candidate 1206 may itself be the reference PDCCH candidate. Thus, the time separation between PDCCH candidates for the purpose of the minimum time separation may be based on the starting symbol of the first PDCCH candidate 1202 and the starting symbol of the third PDCCH candidate 1206. For example, as shown at 1210, if the minimum time separation 808 is configured to be (or supported by the UE as) eleven (11) symbols, the base station 802 may transmit the first pair of linked PDCCH candidates 1203 and the third PDCCH candidate 1206 with the first PDCCH candidate 1202 and the third PDCCH candidate 1206 configured to be at least eleven (11) symbols apart (e.g., between their starting symbols). In another example, as shown by a diagram 1200B of FIG. 12B, the third PDCCH candidate 1206 may also be transmitted between the first PDCCH candidate 1202 and the second PDCCH candidate 1204 of the first pair of linked PDCCH candidates 1203. In this example, as shown at 1212, if the minimum time separation 808 is configured to be (or supported by the UE as) eleven (11) symbols, the base station 802 may transmit the first pair of linked PDCCH candidates 1203 and the third PDCCH candidate 1206 with the first PDCCH candidate 1202 and the third PDCCH candidate 1206 configured to be at least eleven (11) symbols apart (e.g., between their starting symbols).

In another aspect of the present disclosure, as illustrated by (1)(d) at 814 of FIG. 8, the reference PDCCH candidate may be the PDCCH candidate that ends earlier in time in a linked pair of PDCCH candidates. For example, referring back to the diagram 1100A of FIG. 11A, if the reference PDCCH candidate is configured to be the PDCCH candidate that ends earlier in time in a linked pair of PDCCH candidates, then the first PDCCH candidate 1102 may be the reference PDCCH candidate in the first pair of linked PDCCH candidates 1103 as the first PDCCH candidate 1102 ends earlier than the second PDCCH candidate 1104. Similarly, the third PDCCH candidate 1106 may be the reference PDCCH candidate in the second pair of linked PDCCH candidates 1107 as the third PDCCH candidate 1106 ends earlier than the fourth candidate 1108. Thus, the time separation between PDCCH candidates for the purpose of the minimum time separation may be based on the starting symbol of the first PDCCH candidate 1102 and the starting symbol of the third PDCCH candidate 1106. For example, as shown at 1110, if the minimum time separation 808 is configured to be (or supported by the UE as) eleven (11) symbols, the base station 802 may transmit the first pair of linked PDCCH candidates 1103 and the second pair of linked PDCCH candidates 1107 with the first PDCCH candidate 1102 and the third PDCCH candidate 1106 configured to be at least eleven (11) symbols apart (e.g., between their starting symbols). In another example, as shown at 1112 of the diagram 1100B of FIG. 11B, if the minimum time separation 808 is configured to be (or supported by the UE as) five (5) symbols, the base station 802 may transmit the first pair of linked PDCCH candidates 1103 and the second pair of linked PDCCH candidates 1107 with the first PDCCH candidate 1102 and the third PDCCH candidate 1106 configured to be at least five (5) symbols apart (e.g., between their starting symbols).

Similarly, in some examples, one of the consecutive DCI may be transmitted with PDCCH repetition and the other DCI may not be transmitted with PDCCH repetition (e.g., the DCI is received using an individual/unlinked PDCCH candidate). In such examples, the DCI that is not transmitted with PDCCH repetition may not include a reference PDCCH candidate (or in other words, the reference PDCCH candidate may be the individual/unlinked PDCCH candidate). For example, as shown by a diagram 1200A of FIG. 12A, if the reference PDCCH candidate is configured to be the PDCCH candidate that ends earlier in time in a linked pair of PDCCH candidates, then the first PDCCH candidate 1202 may be the reference PDCCH candidate in the first pair of linked PDCCH candidates 1203 as the first PDCCH candidate 1202 ends earlier than the second PDCCH candidate 1204. As the third PDCCH candidate 1206 is not linked to another PDCCH candidate, the third PDCCH candidate 1206 may itself be the reference PDCCH candidate. Thus, the time separation between PDCCH candidates for the purpose of the minimum time separation may be based on the starting symbol of the first PDCCH candidate 1202 and the starting symbol of the third PDCCH candidate 1206. For example, as shown at 1210, if the minimum time separation 808 is configured to be (or supported by the UE as) eleven (11) symbols, the base station 802 may transmit the first pair of linked PDCCH candidates 1203 and the third PDCCH candidate 1206 with the first PDCCH candidate 1202 and the third PDCCH candidate 1206 configured to be at least eleven (11) symbols apart (e.g., between their starting symbols). In another example, as shown by a diagram 1200B of FIG. 12B, the third PDCCH candidate 1206 may also be transmitted between the first PDCCH candidate 1202 and the second PDCCH candidate 1204 of the first pair of linked PDCCH candidates 1203. In this example, as shown at 1212, if the minimum time separation 808 is configured to be (or supported by the UE as) eleven (11) symbols, the base station 802 may transmit the first pair of linked PDCCH candidates 1203 and the third PDCCH candidate 1206 with the first PDCCH candidate 1202 and the third PDCCH candidate 1206 configured to be at least eleven (11) symbols apart (e.g., between their starting symbols).

Referring back to FIG. 8, in another aspect of the present disclosure, as illustrated by (2) at 814 (e.g., Option 2), the minimum time separation 808 may be based on a comparison between a first time separation and a second time separation. In one example, the first time separation may be determined based on either the reference PDCCH candidate being the one that starts later in time in a pair of linked PDCCH candidates (e.g., (1)(a) at 814 of FIG. 8) or the reference PDCCH candidate being the one that ends later in time in a pair of linked PDCCH candidates (e.g., (1)(b) at 814 of FIG. 8), such as described in connection with FIGS. 9A, 9B, 10A, and 10B, and the second time separation may be determined based on either the reference PDCCH candidate being the one that starts earlier in time in a pair of linked PDCCH candidates (e.g., (1)(c) at 814 of FIG. 8) or the reference PDCCH candidate being the one that ends earlier in time in a pair of linked PDCCH candidates (e.g., (1)(d) at 814 of FIG. 8), such as described in connection with FIGS. 11A, 11B, 12A, and 12B. Then, referring back to FIG. 8. Then, the minimum time separation 808 between the first DCI 810 and the second DCI 812 may be determined as a maximum or a minimum between the first time separation and the second time separation.

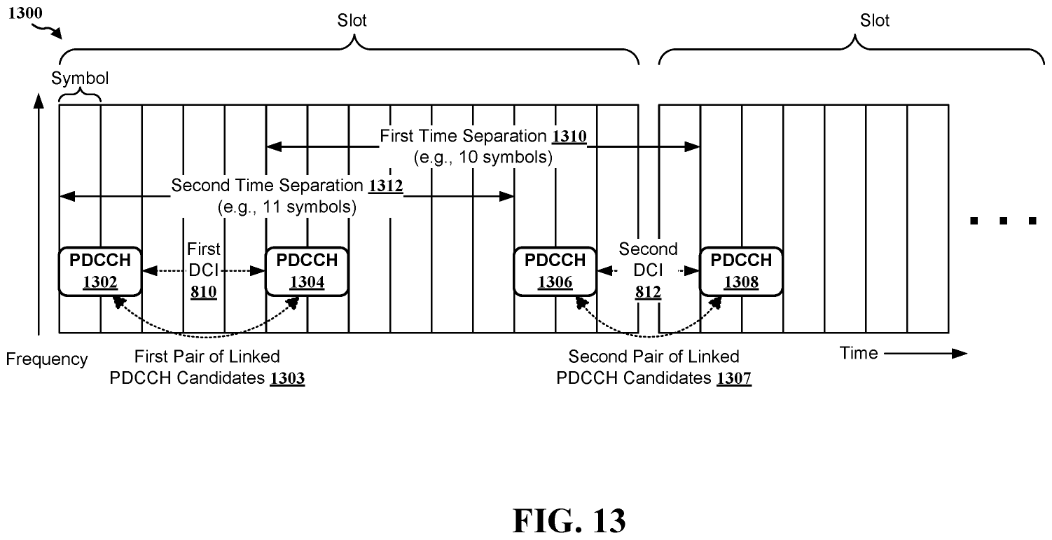

For example, if the first time separation is determined based on the reference PDCCH candidate being the one that starts later in time in a pair of linked PDCCH candidates (e.g., (1)(a) at 814 of FIG. 8) and the second time separation is determined based on the reference PDCCH candidate being the one that starts earlier in time in a pair of linked PDCCH candidates (e.g., (1)(c) at 814 of FIG. 8), the minimum time separation 808 between the first DCI 810 and the second DCI 812 may be based on a greater value between the first time separation and the second time separation, or based on a lesser value between the first time separation and the second time separation. For example, as shown by a diagram 1300 of FIG. 13, a first pair of linked PDCCH candidates 1303 may include a first PDCCH candidate 1302 that is linked to a second PDCCH candidate 1304, which may be used for transmitting the first DCI 810 or a repetition of the first DCI 810. Similarly, a second pair of linked PDCCH candidates 1307 may include a third PDCCH candidate 1306 that is linked to a fourth PDCCH candidate 1308, which may be used for transmitting the second DCI 812 or a repetition of the second DCI 812. If the first time separation 1310 is configured to be based on the reference PDCCH candidate being the one that starts later in time in a pair of linked PDCCH candidates (e.g., (1)(a) at 814 of FIG. 8), then the second PDCCH candidate 1304 may be the reference PDCCH candidate in the first pair of linked PDCCH candidates 1303, and the fourth PDCCH candidate 1308 may be the reference PDCCH candidate in the second pair of linked PDCCH candidates 1307. Thus, the first time separation 1310 may be ten (10) symbols (e.g., from the starting symbol of the second PDCCH candidate 1304 to the starting symbol of the fourth PDCCH candidate 1308) in this example. With regards to the second time separation 1312, if the second time separation 1312 is configured to be based on the reference PDCCH candidate being the one that starts earlier in time in a pair of linked PDCCH candidates (e.g., (1)(c) at 814 of FIG. 8), then the first PDCCH candidate 1302 may be the reference PDCCH candidate in the first pair of linked PDCCH candidates 1303 and the third PDCCH candidate 1306 may be the reference PDCCH candidate in the second pair of linked PDCCH candidates 1307. Thus, the second time separation 1312 may be eleven (11) symbols (e.g., from the starting symbol of the second PDCCH candidate 1304 to the starting symbol of the fourth PDCCH candidate 1308) in this example. As the minimum time separation 808 is configured to be based on a greater value between the first time separation 1310 and the second time separation 1312, the minimum time separation 808 may be eleven (11) symbols for the example illustrated in FIG. 13.

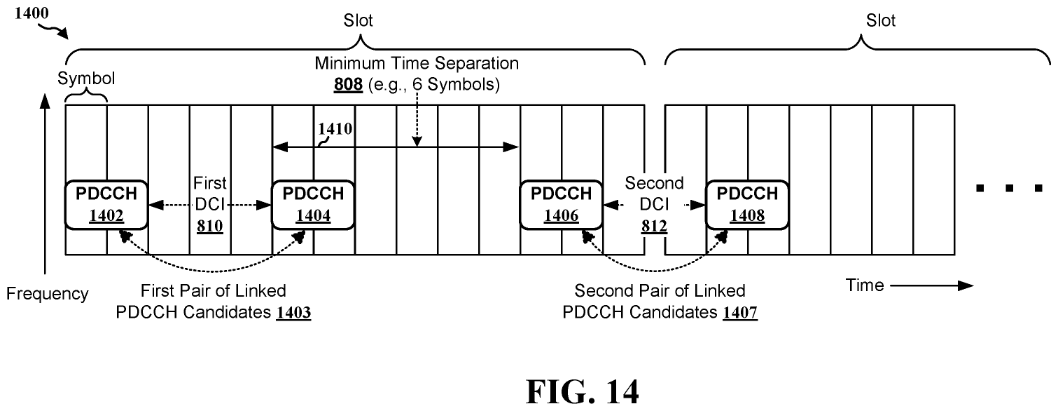

In another aspect of the present disclosure, as illustrated by (3) at 814 of FIG. 8 (e.g., Option 3), the minimum time separation 808 may be defined based on a gap from the later PDCCH repetition of the first DCI to the earlier PDCCH repetition of the second DCI, which may apply to consecutive DCI that are transmitted using PDCCH repetitions. For example, as shown by a diagram 1400 of FIG. 14, a first pair of linked PDCCH candidates 1403 may include a first PDCCH candidate 1402 that is linked to a second PDCCH candidate 1404, which may be used for transmitting the first DCI 810 or a repetition of the first DCI 810, and a second pair of linked PDCCH candidates 1407 may include a third PDCCH candidate 1406 that is linked to a fourth PDCCH candidate 1408, which may be used for transmitting the second DCI 812 or a repetition of the second DCI 812. Thus, the time separation between PDCCH candidates for the purpose of the minimum time separation may be based on the starting symbol of the second PDCCH candidate 1404 and the starting symbol of the third PDCCH candidate 1406. For example, as shown at 1410, if the minimum time separation 808 is configured to be (or supported by the UE as) six (6) symbols, the base station 802 may transmit the first pair of linked PDCCH candidates 1403 and the second pair of linked PDCCH candidates 1407 with the second PDCCH candidate 1404 and the third PDCCH candidate 1406 configured to be at least six (6) symbols apart (e.g., between their starting symbols).

Referring back to FIG. 8, at 816, after the UE 804 transmits the information indicating the UE 804's support for the minimum time separation 808 between monitoring occasions for the first DCI 810 (e.g., a pair of monitoring occasions for the first DCI 810) and the second DCI 812, such as by indicating a capability informing PDCCH monitoring on any occasion with DCI gap, the UE 804 may monitor for and receive DCI from the base station 802 based on the indicated minimum time separation 808 (e.g., with DCI gap). For example, as shown at 818, the base station 802 may apply a time separation between two consecutive DCI transmitted based on the minimum time separation 808 (e.g., Options 1, 2, and 3). In some examples, the minimum time separation 808 may also be configured to satisfy the minimum time separation for different SCSs as described in connection with FIG. 6B. For example, the minimum time separation 808 may include at least two (2) OFDM symbols for 15 kHz SCS, four (4) OFDM symbols for 30 kHz SCS, seven (7) OFDM symbols for 60 kHz SCS with a NCP, and fourteen (14) OFDM symbols for 120 kHz SCS between two consecutive transmissions of PDCCH scrambled with C-RNTI, MCS-C-RNTI, or CS-RNTI, etc.

As described in connection with at least FIGS. 9A, 9B, 10B, 11A, 11B, 12B, 13, and 14, aspects presented herein may apply to cross-slot boundary cases, e.g., across slot boundaries. For example, the minimum time separation may be applicable between DCI that are in a same slot and DCI that are in different slots. In addition, aspects presented herein may apply to DCI scheduling DL and/or UL. For example, the minimum time separation 808 may apply to two DL unicast DCI, between two UL unicast DCI, or between a DL and an UL unicast DCI, etc. Aspects presented herein may also apply to PDCCH monitoring occasions of type 1 CSS with dedicated RRC configuration, type 3 CSS, and UE-SS with DCI scrambled with C-RNTI, MCS-C-RNTI, or CS-RNTI.

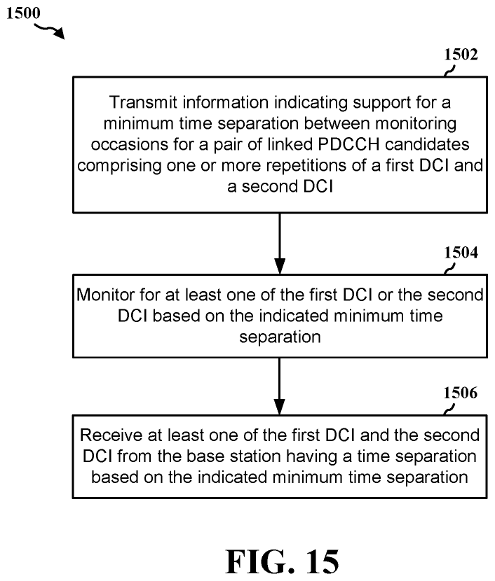

FIG. 15 is a flowchart 1500 of a method of wireless communication. The method may be performed by a UE (which may be an apparatus) or a component of a UE (e.g., the UE 104, 350, 804; the apparatus 1602; a processing system, which may include the memory 360 and which may be the entire UE 350 or a component of the UE 350, such as the TX processor 368, the RX processor 356, and/or the controller/processor 359). The method may enable the UE to indicate a support for a minimum time separation between monitoring occasions of two DCI in which at least one of the two DCI is received from a base station using linked PDCCH repetition.

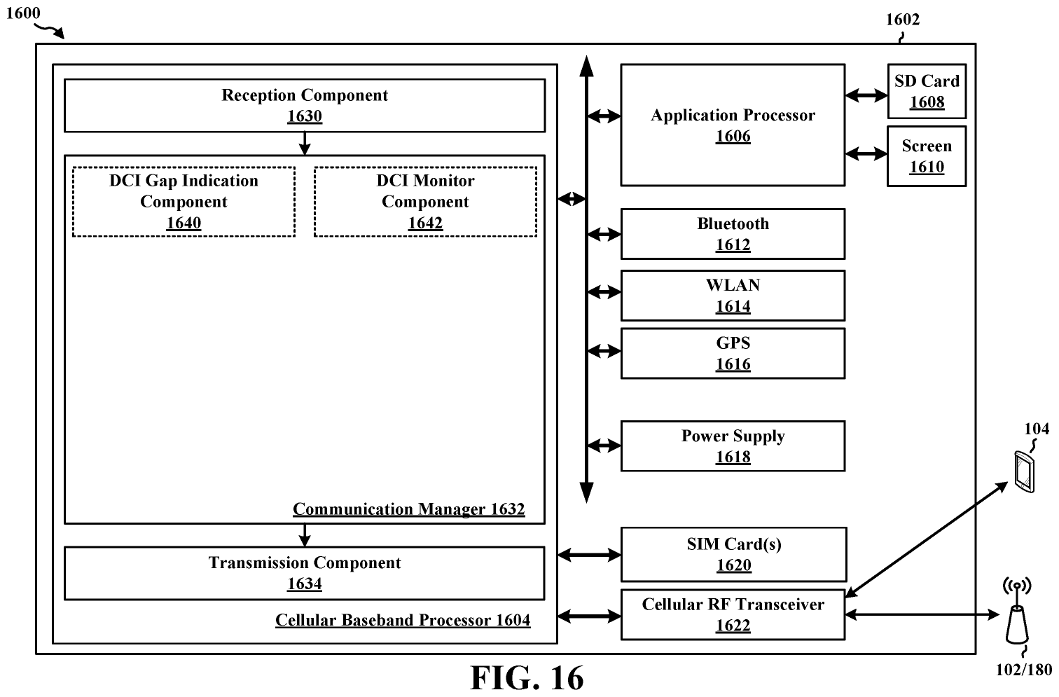

At 1502, the UE may transmit information indicating support for a minimum time separation between monitoring occasions for a pair of linked PDCCH candidates comprising one or more repetitions of a first DCI and a second DCI, such as described in connection with FIG. 8. For example, at 806, the UE 804 may transmit an indication for support of a minimum time separation 808 between the first DCI 810 and the second DCI 812 to the base station 802. The transmission of the indication may be performed, e.g., by the DCI gap indication component 1640 and/or the transmission component 1634 of the apparatus 1602 in FIG. 16. In some examples, the second DCI may include an individual PDCCH candidate DCI.

In one example, the minimum time separation for the pair of linked PDCCH candidates may be based on a reference PDCCH candidate of the pair of linked PDCCH candidates that starts later in time and/or based on a reference PDCCH candidate of the pair of linked PDCCH candidates that ends later in time, such as described in connection with FIGS. 8, 9A, 9B, 10A, 10B.

In another example, the minimum time separation for the pair of linked PDCCH candidates may be based on a reference PDCCH candidate of the pair of linked PDCCH candidates that starts earlier in time and/or based on a reference PDCCH candidate of the pair of linked PDCCH candidates that ends earlier in time, such as described in connection with FIGS. 8, 11A, 11B, 12A, 12B.

In another example, the minimum time separation corresponds to a greater value between the first time separation and the second time separation based on the comparison, or corresponds to a lesser value between the first time separation and the second time separation based on the comparison, such as described in connection with FIGS. 8 and 13. In such an example, the first time separation may be based on a reference PDCCH candidate of the pair of linked PDCCH candidates that starts later in time or ends later in time. In such an example, the second time separation may be based on a reference PDCCH candidate of the pair of linked PDCCH candidates that starts earlier in time or ends earlier in time. Then, the minimum time separation may be based on a greater value or a lesser value between the first time separation and the second time separation.

In another example, the information may indicate the minimum time separation between the pair of linked PDCCH candidates comprising the one or more repetitions of the first DCI and a second pair of linked PDCCH comprising one or more repetitions of the second DCI. In such an example, the minimum time separation may be based on a time separation between a last instance of the first pair of linked PDCCH candidates and a first instance of the second pair of linked PDCCH candidates, such as described in connection with FIGS. 8 and 14. In such an example, the first pair of linked PDCCH candidates may include a first PDCCH candidate followed by a second PDCCH candidate, and the second pair of linked PDCCH candidates may include a third PDCCH candidate followed by a fourth PDCCH candidate.

In some examples, the monitoring occasions may include monitoring for at least one of a type 1 CSS with dedicated RRC configuration, a type 3 CSS, a USS with the DCI scrambled with a C-RNTI, an MCS-C-RNTI, or a CS-RNTI. Also, the monitoring for at least one of the first DCI or the second DCI based on the indicated minimum time separation may further include monitoring for the first DCI and the second DCI in a same slot or in different slots, and the minimum time separation may be based at least in part on an SCS configured for the UE.

At 1504, the UE may monitor for at least one of the first DCI or the second DCI based on the indicated minimum time separation, such as described in connection with FIG. 8 and/or any of the examples described in connection with FIGS. 9A-14. For example, at 816, the UE 804 may monitor for DCI transmitted from the base station 802 based on the indicated minimum time separation. The monitoring of the DCI may be performed, e.g., by the DCI monitor component 1642 and/or the reception component 1630 of the apparatus 1602 in FIG. 16.

As illustrated at 1506, the UE may receive at least one of the first DCI or the second DCI from the base station having a time separation based on the indicated minimum time separation, as described in connection with 1502 and 1504. For example, the UE may receive a first DCI in a first PDCCH candidate monitored by the UE at 1504 and a second DCI in a second DCI monitored by the UE at 1504, the first and second DCI having a separation in time that is based on the minimum time separation that the UE indicated to the base station at 1502. The reception may be performed, e.g., by the reception component 1630 of the apparatus 1602 in FIG. 16.

FIG. 16 is a diagram 1600 illustrating an example of a hardware implementation for an apparatus 1602. The apparatus 1602 is a UE and includes a cellular baseband processor 1604 (also referred to as a modem) coupled to a cellular RF transceiver 1622 and one or more subscriber identity modules (SIM) cards 1620, an application processor 1606 coupled to a secure digital (SD) card 1608 and a screen 1610, a Bluetooth module 1612, a wireless local area network (WLAN) module 1614, a Global Positioning System (GPS) module 1616, and a power supply 1618. The cellular baseband processor 1604 communicates through the cellular RF transceiver 1622 with the UE 104 and/or BS 102/180. The cellular baseband processor 1604 may include a computer-readable medium/memory. The computer-readable medium/memory may be non-transitory. The cellular baseband processor 1604 is responsible for general processing, including the execution of software stored on the computer-readable medium/memory. The software, when executed by the cellular baseband processor 1604, causes the cellular baseband processor 1604 to perform the various functions described supra. The computer-readable medium/memory may also be used for storing data that is manipulated by the cellular baseband processor 1604 when executing software. The cellular baseband processor 1604 further includes a reception component 1630, a communication manager 1632, and a transmission component 1634. The communication manager 1632 includes the one or more illustrated components. The components within the communication manager 1632 may be stored in the computer-readable medium/memory and/or configured as hardware within the cellular baseband processor 1604. The cellular baseband processor 1604 may be a component of the UE 350 and may include the memory 360 and/or at least one of the TX processor 368, the RX processor 356, and the controller/processor 359. In one configuration, the apparatus 1602 may be a modem chip and include just the baseband processor 1604, and in another configuration, the apparatus 1602 may be the entire UE (e.g., see 350 of FIG. 3) and include the additional modules of the apparatus 1602.

The communication manager 1632 includes a DCI gap indication component 1640 that is configured to transmit information indicating support for a minimum time separation between monitoring occasions for a pair of linked PDCCH candidates comprising one or more repetitions of a first DCI and a second DCI, e.g., as described in connection with 1502 of FIG. 15. The communication manager 1632 further includes a DCI monitor component 1642 that is configured to monitor for at least one of the first DCI or the second DCI based on the indicated minimum time separation, e.g., as described in connection with 1504 of FIG. 15.

The apparatus may include additional components that perform each of the blocks of the algorithm in the flowchart of FIG. 15. As such, each block in the flowchart of FIG. 15 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1602, and in particular the cellular baseband processor 1604, includes means for transmitting information indicating support for a minimum time separation between monitoring occasions for a pair of linked PDCCH candidates comprising one or more repetitions of a first DCI and a second DCI (e.g., the DCI gap indication component 1640 and/or the transmission component 1634). The apparatus 1602 includes means for monitoring for at least one of the first DCI or the second DCI based on the indicated minimum time separation (e.g., the DCI monitor component 1642 and/or the reception component 1630).

The means may be one or more of the components of the apparatus 1602 configured to perform the functions recited by the means. As described supra, the apparatus 1602 may include the TX Processor 368, the RX Processor 356, and the controller/processor 359. As such, in one configuration, the means may be the TX Processor 368, the RX Processor 356, and the controller/processor 359 configured to perform the functions recited by the means.

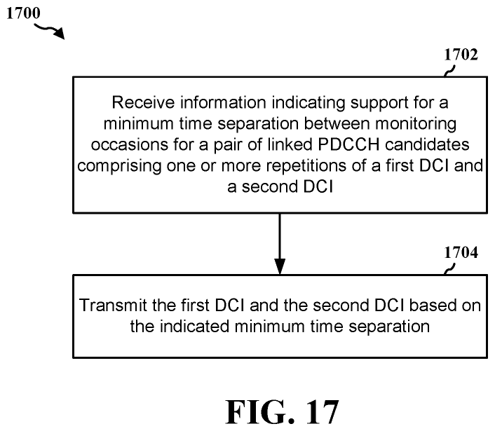

FIG. 17 is a flowchart 1700 of a method of wireless communication. The method may be performed by a base station (which may be an apparatus) or a component of a base station (e.g., the base station 102, 180, 310, 802; the apparatus 1802; a processing system, which may include the memory 376 and which may be the entire base station 310 or a component of the base station 310, such as the TX processor 316, the RX processor 370, and/or the controller/processor 375). The method may enable the base station to transmit two DCI with a minimum time separation based on a UE capability indication received from a UE in which at least one of the two DCI is transmitted using a linked PDCCH repetition.

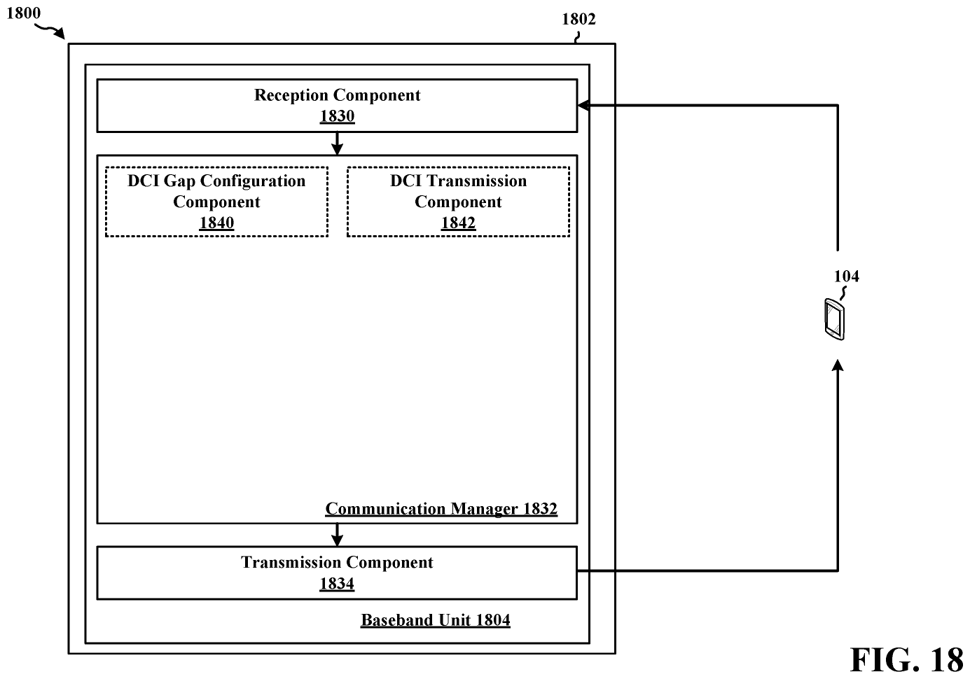

At 1702, the base station may receive information indicating support for a minimum time separation between monitoring occasions for a pair of linked PDCCH candidates comprising one or more repetitions of a first DCI and a second DCI, such as described in connection with FIG. 8. For example, at 806, the base station 802 may receive an indication from the UE 804 for support of a minimum time separation 808 between the first DCI 810 and the second DCI 812. The reception of the indication may be performed, e.g., by the DCI gap configuration component 1840 and/or the reception component 1830 of the apparatus 1802 in FIG. 18. In some examples, the second DCI may include an individual PDCCH candidate DCI.

In one example, the minimum time separation for the pair of linked PDCCH candidates may be based on a reference PDCCH candidate of the pair of linked PDCCH candidates that starts later in time and/or based on a reference PDCCH candidate of the pair of linked PDCCH candidates that ends later in time, such as described in connection with FIGS. 8, 9A, 9B, 10A, 10B.

In another example, the minimum time separation for the pair of linked PDCCH candidates may be based on a reference PDCCH candidate of the pair of linked PDCCH candidates that starts earlier in time and/or based on a reference PDCCH candidate of the pair of linked PDCCH candidates that ends earlier in time, such as described in connection with FIGS. 8, 11A, 11B, 12A, 12B.

In another example, the minimum time separation corresponds to a greater value between the first time separation and the second time separation based on the comparison, or corresponds to a lesser value between the first time separation and the second time separation based on the comparison, such as described in connection with FIGS. 8 and 13. In such an example, the first time separation may be based on a reference PDCCH candidate of the pair of linked PDCCH candidates that starts later in time or ends later in time. In such an example, the second time separation may be based on a reference PDCCH candidate of the pair of linked PDCCH candidates that starts earlier in time or ends earlier in time. Then, the minimum time separation may be based on a greater value or a lesser value between the first time separation and the second time separation.

In another example, the information may indicate the minimum time separation between the first pair of linked PDCCH candidates comprising the repetitions of the first DCI and a second pair of linked PDCCH comprising repetitions of the second DCI. In such an example, the minimum time separation may be based on a time separation between a last repetition of the first pair of linked PDCCH candidates and a first repetition of the second pair of linked PDCCH candidates, such as described in connection with FIGS. 8 and 14. In such an example, the first pair of linked PDCCH candidates may include a first PDCCH candidate followed by a second PDCCH candidate, and the second pair of linked PDCCH candidates may include a third PDCCH candidate followed by a fourth PDCCH candidate.

In some examples, the monitoring occasions may include monitoring for at least one of a type 1 CSS with dedicated RRC configuration, a type 3 CSS, a USS with the DCI scrambled with a C-RNTI, an MCS-C-RNTI, or a CS-RNTI. Also, the minimum time separation may apply to the DCI transmitted from the base station in a same slot or in different slots, and the minimum time separation may be based at least in part on an SCS configured for the UE.

At 1704, the base station may transmit the first DCI and the second DCI based on the indicated minimum time separation, such as described in connection with FIG. 8 and/or any of the examples described in connection with FIGS. 9A-14. For example, at 816, the base station 802 may transmit DCI to the UE 804 based on the indicated minimum time separation. The transmission of the DCI may be performed, e.g., by the DCI transmission component 1842 and/or the transmission component 1834 of the apparatus 1802 in FIG. 18.

FIG. 18 is a diagram 1800 illustrating an example of a hardware implementation for an apparatus 1802. The apparatus 1802 is a BS and includes a baseband unit 1804. The baseband unit 1804 may communicate through a cellular RF transceiver with the UE 104. The baseband unit 1804 may include a computer-readable medium/memory. The baseband unit 1804 is responsible for general processing, including the execution of software stored on the computer-readable medium/memory. The software, when executed by the baseband unit 1804, causes the baseband unit 1804 to perform the various functions described supra. The computer-readable medium/memory may also be used for storing data that is manipulated by the baseband unit 1804 when executing software. The baseband unit 1804 further includes a reception component 1830, a communication manager 1832, and a transmission component 1834. The communication manager 1832 includes the one or more illustrated components. The components within the communication manager 1832 may be stored in the computer-readable medium/memory and/or configured as hardware within the baseband unit 1804. The baseband unit 1804 may be a component of the base station 310 and may include the memory 376 and/or at least one of the TX processor 316, the RX processor 370, and the controller/processor 375.

The communication manager 1832 includes a DCI gap configuration component 1840 that is configured to receive information indicating support for a minimum time separation between monitoring occasions for a pair of linked PDCCH candidates comprising one or more repetitions of a first DCI and a second DCI, e.g., as described in connection with 1702 of FIG. 17. The communication manager 1832 further includes a DCI transmission component 1842 that is configured to transmit the first DCI and the second DCI based on the indicated minimum time separation, e.g., as described in connection with 1704 of FIG. 17.

The apparatus may include additional components that perform each of the blocks of the algorithm in the flowchart of FIG. 17. As such, each block in the flowchart of FIG. 17 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1802, and in particular the baseband unit 1804, includes means for receiving information indicating support for a minimum time separation between monitoring occasions for a pair of linked PDCCH candidates comprising one or more repetitions of a first DCI and a second DCI (e.g., the DCI gap configuration component 1840 and/or the reception component 1830). The apparatus 1802 includes means for transmitting the first DCI and the second DCI based on the indicated minimum time separation (e.g., the DCI transmission component 1842 and/or the transmission component 1834).

The means may be one or more of the components of the apparatus 1802 configured to perform the functions recited by the means. As described supra, the apparatus 1802 may include the TX Processor 316, the RX Processor 370, and the controller/processor 375. As such, in one configuration, the means may be the TX Processor 316, the RX Processor 370, and the controller/processor 375 configured to perform the functions recited by the means.

The following examples set forth additional aspects and are illustrative only and aspects thereof may be combined with aspects of other embodiments or teaching described herein, without limitation.

Aspect 1 is a method of wireless communication, comprising: transmitting information indicating support for a minimum time separation between monitoring occasions for a pair of linked PDCCH candidates comprising one or more repetitions of a first DCI and a second DCI; and monitoring for at least one of the first DCI or the second DCI based on the indicated minimum time separation.

In aspect 2, the method of aspect 1 further includes that the minimum time separation for the pair of linked PDCCH candidates is based on a reference PDCCH candidate of the pair of linked PDCCH candidates that starts later in time.

In aspect 3, the method of aspect 1 or aspect 2 further includes that the minimum time separation for the pair of linked PDCCH candidates is based on a reference PDCCH candidate of the pair of linked PDCCH candidates that ends later in time.

In aspect 4, the method of any of aspects 1-3 further includes that the minimum time separation for the pair of linked PDCCH candidates is based on a reference PDCCH candidate of the pair of linked PDCCH candidates that starts earlier in time.

In aspect 5, the method of any of aspects 1-4 further includes that the minimum time separation for the pair of linked PDCCH candidates is based on a reference PDCCH candidate of the pair of linked PDCCH candidates that ends earlier in time.

In aspect 6, the method of any of aspects 1-5 further includes that the minimum time separation corresponds to a greater value between the first time separation and the second time separation based on the comparison, or corresponds to a lesser value between the first time separation and the second time separation based on the comparison.

In aspect 7, the method of any of aspects 1-6 further includes that the first time separation is based on a reference PDCCH candidate of the pair of linked PDCCH candidates that starts later in time.

In aspect 8, the method of any of aspects 1-7 further includes that the first time separation is based on a reference PDCCH candidate of the pair of linked PDCCH candidates that ends later in time.

In aspect 9, the method of any of aspects 1-8 further includes that the second time separation is based on a reference PDCCH candidate of the pair of linked PDCCH candidates that starts earlier in time.

In aspect 10, the method of any of aspects 1-9 further includes that the second time separation is based on a reference PDCCH candidate of the pair of linked PDCCH candidates that ends earlier in time.

In aspect 11, the method of any of aspects 1-10 further includes that the minimum time separation is based on a greater value between the first time separation and the second time separation.

In aspect 12, the method of any of aspects 1-11 further includes that the minimum time separation is based on a lesser value between the first time separation and the second time separation.

In aspect 13, the method of any of aspects 1-12 further includes that the second DCI comprises an individual PDCCH candidate DCI.

In aspect 14, the method of any of aspects 1-13 further includes that the information indicates the minimum time separation between the pair of linked PDCCH candidates comprising the one or more repetitions of the first DCI and a second pair of linked PDCCH comprising one or more repetitions of the second DCI.

In aspect 15, the method of any of aspects 1-14 further includes that the minimum time separation is based on a time separation between a last instance of the first pair of linked PDCCH candidates and a first instance of the second pair of linked PDCCH candidates.

In aspect 16, the method of any of aspects 1-15 further includes that the first pair of linked PDCCH candidates includes a first PDCCH candidate followed by a second PDCCH candidate, and the second pair of linked PDCCH candidates includes a third PDCCH candidate followed by a fourth PDCCH candidate.

In aspect 17, the method of any of aspects 1-16 further includes that the monitoring occasions include monitoring for at least one of a type 1 CSS with dedicated RRC configuration, a type 3 CSS, a USS with the DCI scrambled with a C-RNTI, an MCS-C-RNTI, or a CS-RNTI.

In aspect 18, the method of any of aspects 1-17, where the monitoring for at least one of the first DCI or the second DCI based on the indicated minimum time separation further includes monitoring for the first DCI and the second DCI in a same slot or in different slots.

In aspect 19, the method of any of aspects 1-18 further includes that the minimum time separation is based at least in part on an SCS configured for an apparatus.

Aspect 20 is an apparatus for wireless communication including at least one processor coupled to a memory and configured to implement a method as in any of aspects 1 to 19.

Aspect 21 is an apparatus for wireless communication including means for implementing a method as in any of aspects 1 to 19.

Aspect 22 is a non-transitory computer-readable medium storing computer executable code, where the code when executed by a processor causes the processor to implement a method as in any of aspects 1 to 19.

Aspect 23 is a method of wireless communication, comprising: receiving information indicating support for a minimum time separation between monitoring occasions for a pair of linked PDCCH candidates comprising one or more repetitions of a first DCI and a second DCI; and transmitting the first DCI and the second DCI based on the indicated minimum time separation.

In aspect 24, the method of aspect 23 further includes that the minimum time separation for the pair of linked PDCCH candidates is based on a reference PDCCH candidate of the pair of linked PDCCH candidates that starts later in time.

In aspect 25, the method of aspect 23 or aspect 24 further includes that the minimum time separation for the pair of linked PDCCH candidates is based on a reference PDCCH candidate of the pair of linked PDCCH candidates that ends later in time.

In aspect 26, the method of any of aspects 23-25 further includes that the minimum time separation for the pair of linked PDCCH candidates is based on a reference PDCCH candidate of the pair of linked PDCCH candidates that starts earlier in time.

In aspect 27, the method of any of aspects 23-26 further includes that the minimum time separation for the pair of linked PDCCH candidates is based on a reference PDCCH candidate of the pair of linked PDCCH candidates that ends earlier in time.

In aspect 28, the method of any of aspects 23-27 further includes that the minimum time separation corresponds to a greater value between the first time separation and the second time separation based on the comparison, or corresponds to a lesser value between the first time separation and the second time separation based on the comparison.

In aspect 29, the method of any of aspects 23-28 further includes that the first time separation is based on a reference PDCCH candidate of the pair of linked PDCCH candidates that starts later in time.

In aspect 30, the method of any of aspects 23-29 further includes that the first time separation is based on a reference PDCCH candidate of the pair of linked PDCCH candidates that ends later in time.

In aspect 31, the method of any of aspects 23-30 further includes that the second time separation is based on a reference PDCCH candidate of the pair of linked PDCCH candidates that starts earlier in time.

In aspect 32, the method of any of aspects 23-31 further includes that the second time separation is based on a reference PDCCH candidate of the pair of linked PDCCH candidates that ends earlier in time.

In aspect 33, the method of any of aspects 23-32 further includes that the minimum time separation is based on a greater value between the first time separation and the second time separation.

In aspect 34, the method of any of aspects 23-33 further includes that the minimum time separation is based on a lesser value between the first time separation and the second time separation.

In aspect 35, the method of any of aspects 23-34 further includes that the second DCI comprises an individual PDCCH candidate DCI.

In aspect 36, the method of any of aspects 23-35 further includes that the information indicates the minimum time separation between the first pair of linked PDCCH candidates comprising the repetitions of the first DCI and a second pair of linked PDCCH comprising repetitions of the second DCI.

In aspect 37, the method of any of aspects 23-36 further includes that the minimum time separation is based on a time separation between a last repetition of the first pair of linked PDCCH candidates and a first repetition of the second pair of linked PDCCH candidates.

In aspect 38, the method of any of aspects 23-37 further includes that the first pair of linked PDCCH candidates includes a first PDCCH candidate followed by a second PDCCH candidate, and the second pair of linked PDCCH candidates includes a third PDCCH candidate followed by a fourth PDCCH candidate.

In aspect 39, the method of any of aspects 23-38 further includes that the monitoring occasions include monitoring for at least one of a type 1 CSS with dedicated RRC configuration, a type 3 CSS, a USS with the DCI scrambled with a C-RNTI, an MCS-C-RNTI, or a CS-RNTI.

In aspect 40, the method of any of aspects 23-39 further includes that the minimum time separation applies to the DCI transmitted from the apparatus in a same slot or in different slots.

In aspect 41, the method of any of aspects 23-40 further includes that the minimum time separation is based at least in part on an SCS configured for a second apparatus.

Aspect 42 is an apparatus for wireless communication including at least one processor coupled to a memory and configured to implement a method as in any of aspects 23 to 41.

Aspect 43 is an apparatus for wireless communication including means for implementing a method as in any of aspects 23 to 41.

Aspect 44 is a non-transitory computer-readable medium storing computer executable code, where the code when executed by a processor causes the processor to implement a method as in any of aspects 23 to 41.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. An apparatus for wireless communication, comprising:
a memory; and
at least one processor coupled to the memory, wherein the at least one processor is configured to:
transmit information indicating support for a minimum time separation between monitoring occasions for a pair of linked physical downlink control channel (PDCCH) candidates comprising one or more repetitions of a first downlink control information (DCI) and a second DCI; and
monitor for at least one of the first DCI or the second DCI based on the indicated minimum time separation.

2. The apparatus of claim 1, wherein the minimum time separation for the pair of linked PDCCH candidates is based on a reference PDCCH candidate of the pair of linked PDCCH candidates that starts later in time or ends later in time.

3. The apparatus of claim 1, wherein the minimum time separation for the pair of linked PDCCH candidates is based on a reference PDCCH candidate of the pair of linked PDCCH candidates that starts earlier in time or ends earlier in time.

4. The apparatus of claim 1, wherein the minimum time separation is based on a comparison of a first time separation and a second time separation.

5. The apparatus of claim 4, wherein the first time separation is based on a reference PDCCH candidate of the pair of linked PDCCH candidates that starts later in time or ends later in time.

6. The apparatus of claim 4, wherein the second time separation is based on a reference PDCCH candidate of the pair of linked PDCCH candidates that starts earlier in time or ends earlier in time.

7. The apparatus of claim 4, wherein the minimum time separation corresponds to a greater value between the first time separation and the second time separation based on the comparison, or corresponds to a lesser value between the first time separation and the second time separation based on the comparison.

8. The apparatus of claim 1, wherein the second DCI comprises an individual PDCCH candidate DCI.

9. The apparatus of claim 1, wherein the information indicates the minimum time separation between the pair of linked PDCCH candidates comprising the one or more repetitions of the first DCI and a second pair of linked PDCCH comprising one or more repetitions of the second DCI.

10. The apparatus of claim 9, wherein the minimum time separation is based on a time separation between a last instance of the first pair of linked PDCCH candidates and a first instance of the second pair of linked PDCCH candidates.

11. The apparatus of claim 9, wherein the first pair of linked PDCCH candidates includes a first PDCCH candidate followed by a second PDCCH candidate, and the second pair of linked PDCCH candidates includes a third PDCCH candidate followed by a fourth PDCCH candidate.

12. The apparatus of claim 1, wherein the monitoring occasions include monitoring for at least one of a type 1 common search space (CSS) with dedicated radio control resource (RRC) configuration, a type 3 CSS, an apparatus-specific search space (USS) with the DCI scrambled with a cell radio network temporary identifier (C-RNTI), a modulation coding scheme C-RNTI (MCS-C-RNTI), or a configured scheduling radio network temporary identifier (CS-RNTI).

13. The apparatus of claim 1, wherein, to monitor for at least one of the first DCI or the second DCI based on the indicated minimum time separation, the at least one processor is configured to monitor for the first DCI and the second DCI in a same slot or in different slots.

14. The apparatus of claim 1, wherein the minimum time separation is based at least in part on a subcarrier spacing (SCS) configured for the apparatus.

15. A method of wireless communication performed by an apparatus, comprising:
transmitting an information indicating support for a minimum time separation between monitoring occasions for a pair of linked physical downlink control channel (PDCCH) candidates comprising one or more repetitions of a first downlink control information (DCI) and a second DCI; and
monitoring for at least one of the first DCI or the second DCI based on the indicated minimum time separation.

16. An apparatus for wireless communication, comprising:
a memory; and
at least one processor coupled to the memory, wherein the at least one processor is configured to:
receive information indicating support for a minimum time separation between monitoring occasions for a pair of linked physical downlink control channel (PDCCH) candidates comprising one or more repetitions of a first downlink control information (DCI) and a second DCI; and
transmit the first DCI and the second DCI based on the indicated minimum time separation.

17. The apparatus of claim 16, wherein the minimum time separation for the pair of linked PDCCH candidates is based on a reference PDCCH candidate of the pair of linked PDCCH candidates that starts later in time or ends later in time.

18. The apparatus of claim 16, wherein the minimum time separation for the pair of linked PDCCH candidates is based on a reference PDCCH candidate of the pair of linked PDCCH candidates that starts earlier in time or ends earlier in time.

19. The apparatus of claim 16, wherein the minimum time separation is based on a comparison of a first time separation and a second time separation.

20. The apparatus of claim 19, wherein the first time separation is based on a reference PDCCH candidate of the pair of linked PDCCH candidates that starts later in time or ends later in time.

21. The apparatus of claim 19, wherein the second time separation is based on a reference PDCCH candidate of the pair of linked PDCCH candidates that starts earlier in time or ends earlier in time.

22. The apparatus of claim 19, wherein the minimum time separation corresponds to a greater value between the first time separation and the second time separation based on the comparison, or corresponds to a lesser value between the first time separation and the second time separation based on the comparison.

23. The apparatus of claim 16, wherein the second DCI comprises an individual PDCCH candidate DCI.

24. The apparatus of claim 16, wherein the information indicates the minimum time separation between the pair of linked PDCCH candidates comprising the one or more repetitions of the first DCI and a second pair of linked PDCCH comprising one or more repetitions of the second DCI.

25. The apparatus of claim 24, wherein the minimum time separation is based on a time separation between a last instance of the first pair of linked PDCCH candidates and a first instance of the second pair of linked PDCCH candidates.

26. The apparatus of claim 24, wherein the first pair of linked PDCCH candidates includes a first PDCCH candidate followed by a second PDCCH candidate, and the second pair of linked PDCCH candidates includes a third PDCCH candidate followed by a fourth PDCCH candidate.

27. The apparatus of claim 16, wherein the monitoring occasions include monitoring for at least one of a type 1 common search space (CSS) with dedicated radio control resource (RRC) configuration, a type 3 CSS, an apparatus-specific search space (USS) with the DCI scrambled with a cell radio network temporary identifier (C-RNTI), a modulation coding scheme C-RNTI (MCS-C-RNTI), or a configured scheduling radio network temporary identifier (CS-RNTI).

28. The apparatus of claim 16, wherein the minimum time separation applies to the first DCI and the second DCI transmitted from the apparatus in a same slot or in different slots.

29. The apparatus of claim 16, wherein the minimum time separation is based at least in part on a subcarrier spacing (SCS) configured for a second apparatus.

30. A method of wireless communication performed by an apparatus, comprising:
receiving information indicating support for a minimum time separation between monitoring occasions for a pair of linked physical downlink control channel (PDCCH) candidates comprising one or more repetitions of a first downlink control information (DCI) and a second DCI; and
transmitting the first DCI and the second DCI based on the indicated minimum time separation.
